(19) United States
(12) Patent Application Publication
(10) Pub. No.: US 2023/0046322 A1
(43) Pub. Date: Feb. 16, 2023

(54) ROBOTIC PROCESS AUTOMATION SYSTEM FOR MANAGING HUMAN, ROBOTIC AND EXTERNAL TASKS

(71) Applicant: Automation Anywhere, Inc., San Jose, CA (US)

(72) Inventors: Perv Rastogi, San Jose, CA (US); Sheeba Ann George, Santa Clara, CA (US); Senthil Kumar Pandurangan, Cupertino, CA (US)

(21) Appl. No.: 17/828,021

(22) Filed: May 30, 2022

Related U.S. Application Data
(60) Provisional application No. 63/285,081, filed on Dec. 1, 2021.
(60) Provisional application No. 63/231,695, filed on Aug. 10, 2021.

(51) Int. Cl. G06F 9/48; G06F 9/451; G05B 19/418; G06V 30/41; G06V 30/24

(52) U.S. Cl. CPC G06F 9/4881; G06F 9/451; G05B 19/41835; G06V 30/41; G06V 30/24

(57) ABSTRACT

Improved techniques for combining human tasks with robotic tasks and/or external tasks in an organized manner to define an automation workflow process for use by a software automation system. A workflow process platform can assist a developer in creating an automation workflow process and/or managing performance of an automation workflow process. The automation workflow process can carry out a process, such as a business process, by interrelating human tasks performed by users with robotic tasks performed by computing machines or external tasks performed by applications (e.g., local or cloud-based). The workflow process platform can be network-based and utilize various users and computing machines that are affiliated with different groups (e.g., teams, departments) of an organization. Advantageously, the improved techniques can enable automation of business processes using various persons, robotic agents and/or applications in an organized and controlled manner.

### CROSS-REFERENCE TO RELATED APPLICATIONS

This application claims priority to U.S. Patent Provisional Application No. 63/285,081, filed Dec. 1, 2021, and entitled “ROBOTIC PROCESS AUTOMATION FOR MANAGING HUMAN, ROBOTIC AND EXTERNAL TASKS,” which is hereby incorporated herein by reference.

This application also claims priority to U.S. Patent Provisional Application No. 63/231,695, filed Aug. 10, 2021, and entitled “ROBOTIC PROCESS AUTOMATION FOR MANAGING HUMAN AND ROBOTIC TASKS,” which is hereby incorporated herein by reference.

### BACKGROUND OF THE INVENTION

Robotic Process Automation (RPA) systems enable automation of repetitive and manually intensive computer-based tasks. In an RPA system, computer software, namely a software robot (often referred to as a “bot”), may mimic the actions of a human being in order to perform various computer-based tasks. For instance, an RPA system can be used to interact with one or more software applications through user interfaces, as a human being would do. Therefore, RPA systems typically do not need to be integrated with existing software applications at a programming level, thereby eliminating the difficulties inherent with such integration. Advantageously, RPA systems permit the automation of application level repetitive tasks via software robots that are coded to repeatedly and accurately perform the repetitive tasks.

RPA systems have generally assisted users in creating software robots that mimic user interactions with software applications to perform various tasks. These software robots are normally used to automate tasks for a particular user. However, tasks are often combined to perform a process that involves various different departments or persons of an enterprise. Conventionally, software robots are used in an isolated manner for particular users, and thus are not easily used in combination, especially when various users and/or client machines are involved. As such, although software robots can be utilized to carry out tasks, there remains inefficiencies and complications in carrying out automated processing across different users, departments, or businesses.

Therefore, there is a need for improved approaches to utilize software robots for RPA systems in an interrelated manner, especially when involving various users and various computing machines.

### SUMMARY

Embodiments disclosed herein concern improved techniques for combining human tasks with robotic tasks and/or external tasks in an organized manner to define an automation workflow process. A workflow process platform can assist a developer in creating an automation workflow process and/or managing performance of an automation workflow process. The automation workflow process can carry out a process, such as a business process, by interrelating human tasks performed by users with robotic tasks performed by robotic agents operating on computing machines or external tasks performed by applications (e.g., local or cloud-based). The workflow process platform can be network-based and utilize various users and computing machines that are affiliated with different groups (e.g., teams, departments) of an organization. Advantageously, the improved techniques can enable automation of business processes using various persons, robotic agents and/or applications in an organized and controlled manner.

The invention can be implemented in numerous ways, including as a method, system, device, or apparatus (including computer readable medium and graphical user interface). Several exemplary embodiments of the invention are discussed below.

As a non-transitory computer readable medium including at least computer program code stored thereon for managing an automation workflow process capable of utilizing one or more software robots, one or more external applications and/or one or more human inputs, one embodiment can, for example, include at least: computer program code for processing a dataset by a first software robot to produce an automation result; computer program code for detecting completion of the first software robot; computer program code for processing the automation result by a first external application to produce processed data; computer program code for detecting completion of the first external application; computer program code for presenting a user interface including at least a portion of the processed data; and computer program code for detecting receipt of a human input with respect to the user interface.

As a non-transitory computer readable medium including at least computer program code stored thereon for managing an automation workflow process capable of utilizing one or more software robots, one or more external applications and/or one or more human inputs, one embodiment can, for example, include at least: computer program code for processing a dataset by a first external application to produce processed data; computer program code for detecting completion of the first external application; computer program code for presenting a user interface including at least a portion of the processed data; and computer program code for detecting receipt of a human input with respect to the user interface.

As a non-transitory computer readable medium including at least computer program code stored thereon for managing a workflow process using a software automation system, one embodiment can, for example, include at least: computer program code for providing input information to and requesting information from an external software application; computer program code for receiving output information from the external software application; computer program code for determining a characteristic of the output information that impacts the ability of the output information to be successfully utilized as input information for use by the software automation system or the workflow process; computer program code for presenting a user interface able to receive user input from a human user; and computer program code for receiving, via the user interface, a first input from the human user that supplements or alters the output information from the external application.

As a robotic process automation system, one embodiment can, for example, include at least: a data store configured to store a plurality of software robots, the software robots providing automated interaction with one or more software programs operating on one or more computing devices; and a workflow process platform configured to enable users to (i) create automation workflow processes, and (ii) perform automation workflow processes that have been created. At least a particular automation workflow process of the created automation workflow processes can include a determined sequence of performing a plurality of tasks, where at least one of the tasks in the determined sequence being a robotic task that is performed by one of the software robots, at least another of the tasks in the determined sequence being a human task that is performed to receive interaction with a person, and at least another of the tasks in the determined sequence being an interaction with a software application. Also, performance of the particular automation workflow process can perform the tasks of the particular automation workflow process in the determined sequence, with the performance including causing the one of the software robots for the robotic task to be performed, causing a user interface to be presented to the person in performing the human task, and causing interaction with the software application to provide data to the software application and received returned data from the software application.

As a non-transitory computer readable medium including at least computer program code stored thereon for managing an automation workflow process utilizing software robots, external applications and human input, one embodiment can, for example, include at least: computer program code for identifying a first human task to be included in the automation workflow process being created; computer program code for configuring the first human task to present a user interface to a person and to capture a data input therefrom; computer program code for identifying a first robotic task to be included in the automation workflow process being created; computer program code for arranging the first robotic task to follow after the first human task within the automation workflow process being created; computer program code for configuring the first robotic task to utilize a first software robot, and to receive as an input at least a portion of the data input that the first human task provided; computer program code for identifying a first external application to be accessed during the automation workflow process being created; computer program code for arranging the first external application to be accessed following after the first human task or the first robotic task within the automation workflow process; and computer program code for configuring the automation workflow process to receive data from the first external application being accessed.

As a method for managing a workflow process using a software automation system, one embodiment can, for example, include at least: receiving, at the software automation system, output information from an external software application; determining a quality of the output information, the quality of the output information corresponding to the ability of the output information to be successfully utilized as input information by the software automation system in carrying out the workflow process; presenting a user interface configured to receive user input from a human user; and receiving, via the user interface, (i) a first input comprising human input that supplements or alters the output information from the external application, and/or (ii) a second input comprising an instruction to utilize the received output information and/or the human input as input information for use by the software automation system in carrying out the workflow process.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a diagram of an RPA environment according to one embodiment.

FIG. 2 illustrates a block diagram of a workflow process platform according to one embodiment.

FIG. 3 is a flow diagram of a workflow execution process according to one embodiment.

FIG. 4 is a flow diagram of a workflow coordination process according to one embodiment.

FIG. 5 illustrates a block diagram of an RPA system according to one embodiment.

FIG. 6 is a block diagram of a distributed workflow process according to one embodiment.

FIG. 7 is a block diagram of an employee onboarding workflow process according to one embodiment.

FIGS. 8A-8D are exemplary screenshots of configuration screens that can be used to configure operation of an automation workflow process, according to one embodiment.

FIG. 9 is s screenshot of an exemplary form that can be present to a person in content of a human task, according to one embodiment.

FIG. 10 illustrates a block diagram of an automation workflow process according to one embodiment.

FIG. 11 illustrates a flow diagram of a document labeling workflow process according to one embodiment.

FIG. 12 illustrates a flow diagram of a data extraction workflow process according to one embodiment.

FIG. 13 illustrates a block diagram of an automation workflow process according to one embodiment.

FIG. 14 illustrates a flow diagram of a document signing workflow process according to one embodiment.

FIG. 15 illustrates a block diagram of an automation workflow process according to one embodiment.

FIG. 16 illustrates a flow diagram of a data extraction workflow process according to one embodiment.

FIG. 17 illustrates a visual representation of an exemplary workflow process for data extraction.

FIG. 18 illustrates a user interface for configuring a task to participate within a workflow process according to one embodiment.

FIG. 19 illustrates a user interface for creating a learning instance workflow 1902 according to one embodiment.

FIG. 20A illustrates a user interface for selection of fields for data extraction according to one embodiment.

FIG. 20B illustrates a user interface for configuration of extraction processing for a selected field according to one embodiment.

FIG. 21 illustrates a user interface for identification of previously created learning instances according to one embodiment.

FIG. 22 illustrates a user interface for designating input documents and an output data destination for one or more documents to be processed by a workflow process, according to one embodiment.

FIG. 23A illustrates a user interface providing completion status for steps of an exemplary workflow process.

FIG. 23B illustrates a user interface presenting an annotated document according to one embodiment.

FIG. 23C illustrated a validation user interface according to one embodiment.

FIG. 24A illustrates a user interface illustrating a validation queue according to one embodiment.

FIG. 24B illustrates a user interface presenting an annotated document according to one embodiment.

FIG. 24C illustrated a validation user interface according to one embodiment

FIG. 25 illustrates a user interface illustrating a validation queue according to one embodiment.

FIG. 26 is a block diagram of an RPA system according to one embodiment.

FIG. 27 is a block diagram of a generalized runtime environment for software robots (e.g., bots) in accordance with another embodiment of the RPA system illustrated in FIG. 26.

FIG. 28 illustrates yet another embodiment of the RPA system of FIG. 26 configured to provide platform independent sets of task processing instructions for software robots.

FIG. 29 is a block diagram illustrating details of one embodiment of bot compiler illustrated in FIG. 28.

FIG. 30 illustrates a block diagram of an exemplary computing environment for an implementation of an RPA system, such as the RPA systems disclosed herein.

### DETAILED DESCRIPTION OF CERTAIN EMBODIMENTS

Embodiments disclosed herein concern improved techniques for combining human tasks with robotic tasks and/or external tasks in an organized manner to define an automation workflow process for use by a software automation system. A workflow process platform can assist a developer in creating an automation workflow process and/or managing performance of an automation workflow process. The improved techniques enable an RPA system to support programmatically combining various robotic tasks and/or external tasks with human actions to provide an interrelated relationship of human tasks, automated tasks, and external tasks. The external tasks can be implemented by software application that are external to the software automation system.

An automation workflow process can carry out a process, such as a business process. By interrelating human tasks performed by users with robotic tasks performed by robotic agents operating on computing machines or external agents performed by applications (e.g., local or cloud-based), the workflow process platform can be network-based and utilize various users and computing machines that are affiliated with different groups (e.g., teams, departments) of an organization. Advantageously, the improved techniques can enable automation of business processes using various persons and robotic agents as well as external applications in an organized and controlled manner.

Generally speaking, RPA systems use computer software to emulate and integrate the actions of a human interacting within digital systems. In an enterprise environment, these RPA systems are often designed to execute a business process. In some cases, the RPA systems use Artificial Intelligence (Al) and/or other machine learning capabilities to handle high-volume, repeatable tasks that previously required humans to perform. The RPA systems support a plurality of software robots. More specifically, the RPA systems provide for creation, configuration, management, execution, monitoring, and/or performance of software robots.

Software robots can also be referred to as robotic agents, software agents, or bots. A software robot can interpret and execute tasks on your behalf. Software robots are particularly well suited for handling a lot of the repetitive tasks that humans perform every day. Software robots can perform a task they are tasked with and do it consistently and reliably each time. As one example, a software automation process can locate and read data in a document, email, file, or window. As another example, a software robot can connect with one or more Enterprise Resource Planning (ERP), Customer Relations Management (CRM), core banking, and other business systems to distribute data where it needs to be in whatever format is necessary. As another example, a software robot can perform data tasks, such as reformatting, extracting, balancing, error checking, moving, copying, and the like. As another example, a software robot can grab data desired from a webpage, application, screen, file, or other data source. As still another example, a software robot can be triggered based on time or an event, and can serve to take files or data sets and move them to another location, whether it is to a customer, vendor, application, department, or storage.

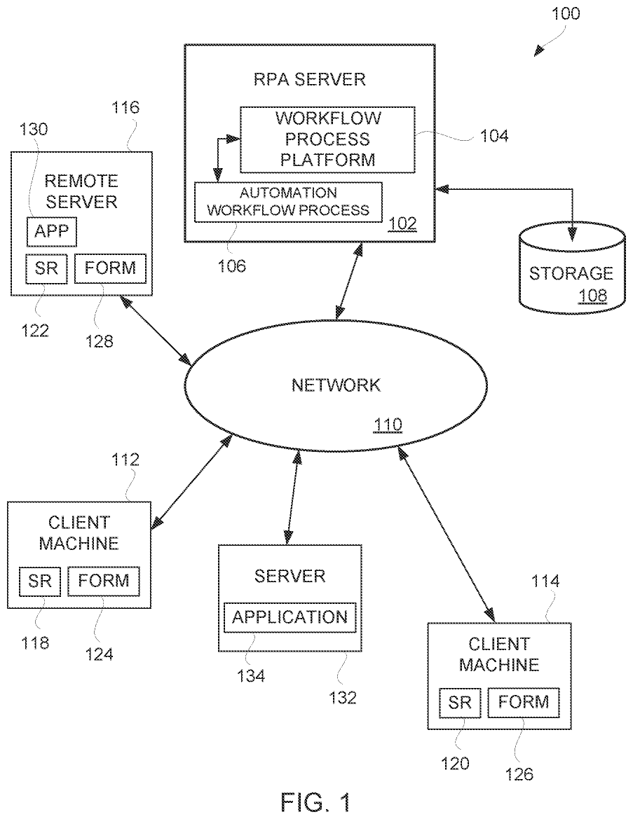

Embodiments of various aspects of the invention are discussed below with reference to FIGS. 1-30. However, those skilled in the art will readily appreciate that the detailed description given herein with respect to these figures is for explanatory purposes as the invention extends beyond these limited embodiments.

The various aspects disclosed herein can be utilized with or by robotic process automation systems. Exemplary robotic process automation systems and operations thereof are detailed below.

FIG. 1 is a diagram of an RPA environment 100 according to one embodiment. The RPA environment 100 includes an RPA server 102. The RPA server 102 supports a workflow process platform 104. The workflow process platform 104 can facilitate creation, storage and performance of automation workflow processes 106. For example, the workflow process platform 104 can carry out a process, such as a business process. More particularly, the process to be carried out by the workflow process platform 104 can be defined by an automation workflow process 106 that identifies a series of tasks, whether provided by humans or by software robots (i.e., robotic agents), that together are used to carry out the process. The automation workflow platform can then perform (e.g., execute) the automation workflow process 106 in which case the series of tasks that carry out the process are performed. The automation workflow process 106 defines tasks to be performed, permits exchange of data amongst the tasks, and supports conditional logic for added robustness. The automation workflow process 106 is a computer readable description that can be interpreted by the computing device operating the workflow process platform 104 or can be compiled into executable process code that can be executed by the computing device operating the workflow process platform 104.

The RPA environment 100 is typically operated over a plurality of different computing devices that can be associated with different departments of an organization, different locations of an organization, different users, or even different organizations. These different computing devices can interact with one another via one or more networks 110. As examples, the RPA environment 100 can include client machine 112, client machine 114, and remote server 116. The computing devices can, for example, be desktop computers, personal computers, server computers, laptops, tablets, or any other known portable computing devices. The RPA environment 100 can also couple to a storage unit 108 that can store a plurality of automation workflow processes and/or software robots. The storage unit 108 can provide local storage or central repository storage.

In carrying out the automation workflow process 106, the workflow process platform 104 can activate tasks on any of the different computing devices. Each task can be a human task or a robotic (or “bot”) task. The robotic task is an automated task carried out by a software robot (or robotic agent). Additionally, the workflow process platform 104 can also utilize processing at the RPA server 102 to control, manage and monitor performance of the automation workflow process 106.

As illustrated in FIG. 1, the client machine 112 can support a human task that can present a user interface, or a robotic task that can utilize a software robot 118. Similarly, the client machine 114 can support a human task that can present a user interface, or can support a robotic task that can utilize a software robot 120. Further still, the remote server 116 can utilize a software robot 122 to perform robotic tasks.

The robotic tasks may be performed by software robots 118, 120, 122. The software robots 118, 120, 122 for the robotic tasks to be carried out can reside locally at the client machine 112, 114 or server 116, or can be retrieved from the workflow process platform 104 or a central repository (e.g., storage 108). In one example, the RPA server 102 can include or couple to a central repository for software robots. The RPA server 102 can also support a RPA system that permits creation of software robots.

The human tasks are tasks that involves human interaction. In one implementation, a human task can be to present a graphical user interface to a user that displays an electronic form 124, 126, 128 on a display. A user can interact with the form 124, 126, 128 to enter information that can be submitted back to the workflow flow process platform 104. The forms 124, 126, 128 used for human tasks can also reside locally at the client machine 112, 114 or server 116, or can be retrieved from the workflow process platform 104 or a central repository. In one example, the RPA server 102 can include or couple to a central repository (e.g., storage 108) for the form.

The RPA system 100 can also support external tasks that are carried out by software application operating on computing devices. For example, as shown in FIG. 1, the RPA system 100, and thus the automation workflow process 106, can also use external tasks. As one example, the remote server 116 can include an application 130 that can be access as an external task. As another example, the RPA system 100 can access a server 132 supporting an application 134. The applications can vary widely in terms of functionality and usage. The applications can be first-party applications or third-party applications (e.g., Workday™, Salesforce™, etc.).

In one embodiment, the external task can be integrated into the workflow process. This integration can, for example, be achieved by specifying an application that is to be used by the external task. The needed data for the application can then be configured to be provided to the application by the workflow process. The needed data can be status data or dynamically determined earlier in the workflow process. The application returns data to the workflow process that can then operate on the returned data.

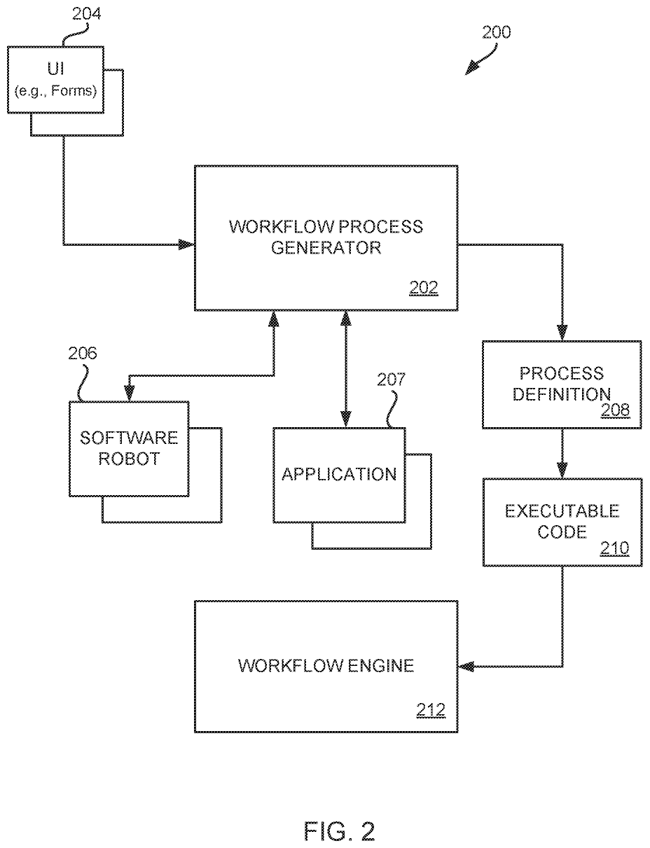

FIG. 2 illustrates a block diagram of a workflow process platform 200 according to one embodiment. The workflow process platform 200 can, for example, pertain to the workflow process platform 104 illustrated in FIG. 1.

The workflow process platform 200 can include a workflow process generator 202. The workflow process generator 202 is configured to enable a user to generate an automation workflow process. In doing so, the user can create and or select one or more user interfaces 204 (e.g., forms) to be utilized in the automation workflow process. Additionally, the user can create and/or select one or more software robots 206 (robotic agents) to be utilized in the automation workflow process. The user can also choose to communicate with one or more software applications 207. Further still, the user can additionally include process flow logic (e.g., conditional logic), such as checkpoints, branches or validations, that are to occur in the automation workflow process. As a result, the workflow process generator 202 can yield an automation workflow process that is defined by a process definition 208. As an example, the process definition 208 for an automation workflow process can have a JavaScript Object Notation (JSON) format. JSON is a standard text-based format for representing structured data based on JavaScript object syntax.

Additionally, the workflow process platform 200 can compile the process definition 208 to yield executable code 210. The process definition 208 or the executable code 210 can be later executed by the workflow process platform 200 to carry out the automation workflow process. The workflow process platform 200 can also include a workflow engine 212. The workflow engine 212 can carry out the automation workflow process. To do so, the workflow engine 212 can interpret and perform the process definition 208 or can execute the executable code 210.

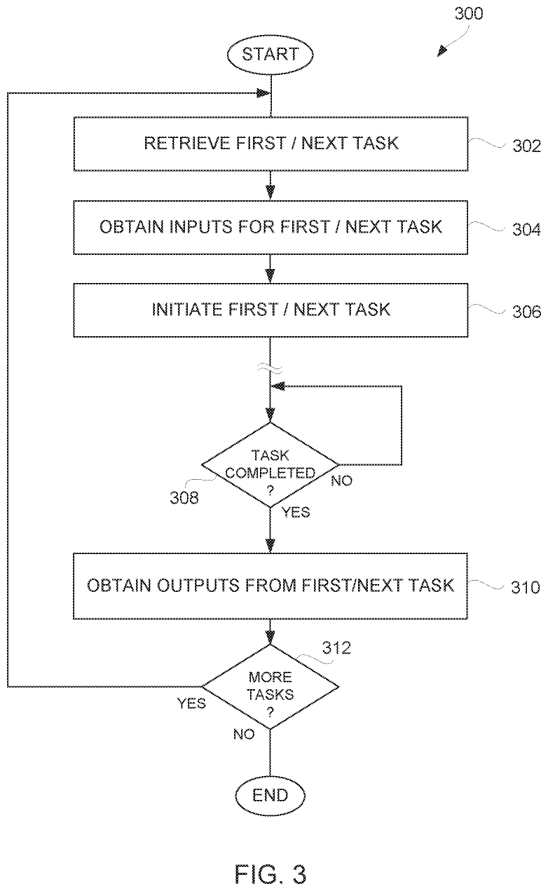

FIG. 3 is a flow diagram of a workflow execution process 300 according to one embodiment. The workflow execution process 300 is, for example, performed by a workflow process platform, such as the workflow process platform 104 illustrated in FIG. 1.

The workflow execution process 300 carries out an automation workflow process that has previously been created. The workflow execution process 300 can retrieve 302 a first task of the automation workflow process being performed. In addition, any inputs needed for the first task can be obtained 304. Thereafter, the first task can be initiated 306. Here, the workflow execution process 300 can request that a particular computing device perform the first task. The particular computing device would be a computing device associated to a user, department, team of users, etc. For example, if the automation workflow process concerns approval of a purchase order, then the first task might be for a user in the sales department to specify a purchase order number for the purchase order that is to be approved.

At this point, the workflow execution process 300 is not required to do anything until the first task indicates that it has completed its task. In other words, the workflow execution process 300 can be stateless and thus need not continuously monitor or await the completion of the first task. For example, in the example where the first task seeks input from a user in the sales department, that might take seconds, minutes, hours or days. During such undetermined time, the workflow execution process 300 can be inactive. In other words, the execution of the automation workflow process by the workflow execution process 300 operates asynchronously.

However, after the first task reports back to the workflow execution process 300 that it has been completed, as detected by decision 308, the workflow execution process 300 can obtain 310 any outputs from the first task. Thereafter, a decision 312 can determine whether the automation workflow process has any additional tasks that are to be performed.

When the decision 312 determines that there are more tasks to be performed, then the workflow execution process 300 can return to the block 302 and subsequent blocks so that a next task within the particular workflow process can be carried out in a similar fashion. As such, the workflow execution process 300 can retrieve 302 a next task of the automation workflow process being performed. Then, any inputs needed for the next task can be obtained 304. Thereafter, the next task can be initiated 306. Here, the workflow execution process 300 can request that a particular computing device perform the next task. The particular computing device would be a computing device associated with a user, department, team of users, etc. For example, if the automation workflow process concerns automated processing of the purchase order to import its details into a database, then the next task might be to launch a software robot (robotic agent) using a computing device in sales department to carry out the importing of the purchase order details into a database. Again, the workflow execution process 300 is not required to do anything until the software robot completes its task. Once the next task reports back to the workflow execution process 300 that it has been completed, as detected by the decision 308, the workflow execution process 300 can obtain 310 any outputs from the next task. Thereafter, a decision 312 can determine whether the automation workflow process has any additional tasks that are to be performed.

When the decision 312 determines that there are more tasks to be performed, then the workflow execution process 300 can return to block 302 and subsequent blocks so that a next task within the automation workflow process can be carried out in a similar fashion. On the other hand, once the decision 312 determines that there are no additional tasks to be performed by the automation workflow process, the workflow execution process 300 can end.

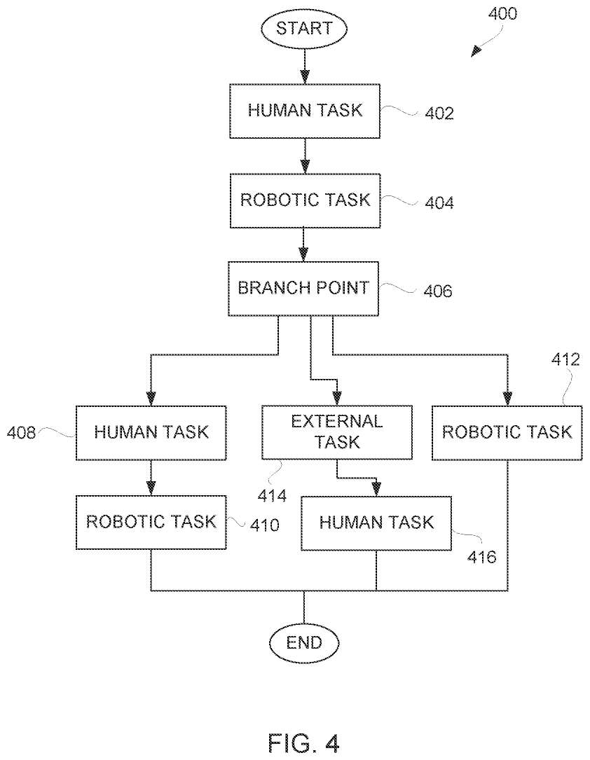

FIG. 4 is a flow diagram of a workflow coordination process 400 according to one embodiment. The workflow coordination process 400 illustrates that an automation workflow process can utilize a combination of human tasks along with robotic tasks to carry out an automation workflow process. The workflow coordination process 400 also indicates that conditional logic for branching can be included within an automation workflow process to support more sophisticated workflow processes.

The workflow coordination process 400 illustrated in FIG. 4 illustrates that the automation workflow process to be carried out can include a sequential arrangement of human tasks, robotic tasks, and/or branching points that together carry out the automation workflow process. In this embodiment, the workflow coordination process 400, once started, initiates a human task 402. Then, following the human task 402, a robotic task 404 can be performed.

After the robotic task 404, a branch point 406 in the workflow process 400 can be reached. The branch point 406 can utilize conditional logic to decide which of two or more processing branches are to be utilized. As illustrated in FIG. 4, following a first branch from the branch point 406, a human task 408 can be carried out and then a robotic task 410 can be carried out. Alternatively, in a second branch from the branch point 406, a robotic task 412 can be performed. Further, following a third branch from the branch point 406, an external task 414 can be carried out and then a human task 416 can be carried out. Whether the first branch, the second branch or the third branch is taken depends on conditional logic and evaluation of associated conditions. As an example, a workflow execution engine, can evaluate the conditional logic based on data provided by the previous processing of the workflow coordination process 400 (or data otherwise available thereto). Following the robotic task 410 or the robotic task 412, the workflow coordination process 400 can end.

It should be recognized that the workflow coordination process 400 is a simplified embodiment. In general, human, robotic and external tasks can be ordered and arranged in many different sequences, and may also include one or more branching points. As such, the ordering of human, robotic and external tasks can be arranged in any sequence. Although the workflow coordination process 400 starts with the human task 402 followed by the robotic task 404, in alternative embodiment a workflow coordination process can start with a robotic task which can be followed by a human task or another robotic task.

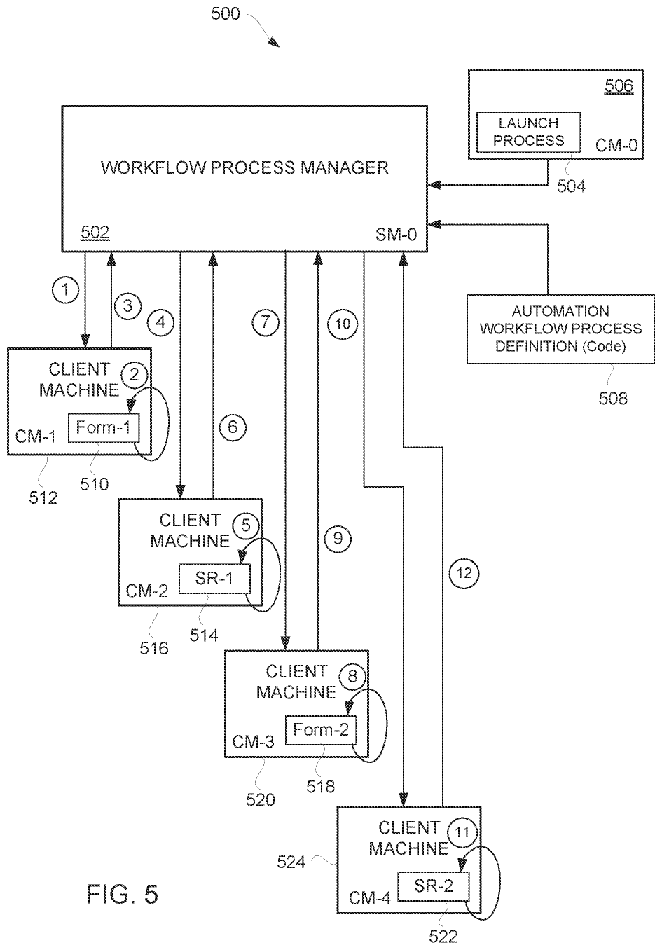

FIG. 5 illustrates a block diagram of an RPA system 500 according to one embodiment. The RPA system 500 includes a workflow process manager 502 that is capable of performing (e.g., launching) an automation workflow process 504. The workflow process manager 502 can, in one implementation, be included within the workflow process platform 104 illustrated in FIG. 1. The automation workflow process 504 that is to be performed can be created by the workflow process platform 104 illustrated in FIG. 1 or the workflow process generator 202 illustrated in FIG. 2. In one implementation, the workflow process manager 502 operates on a server machine (SM-0), such as the RPA server 102 illustrated in FIG. 1.

To initiate the automation workflow process 504, a launch request can be received by the workflow process manager 502. The launch request can be initiated manually by a user or automatically by programmatic code. In one implementation, this launch request can be carried out on a client machine 506 (CM-0). The automation workflow process 504 to be carried out can be described by a workflow process definition 508. The workflow process definition 508 is typically either a computer readable structured description of the processing to be carried out or executable code derived therefrom. The particular workflow process definition 508 can be stored in a repository or data storage accessible to the workflow process manager 502. Alternatively, the particular workflow process definition 508 can be stored in the client machine 506 (CM-0).

The workflow process manager 502 carries out the automation workflow process 504. In doing so, the workflow process manager 502 can interact with various different computing devices where robotic agents and/or users or teams of users can participate in performing portions of the automation workflow process 504.

More particularly, in one embodiment, the workflow process manager 502 can initially present a form 510 (Form-1) to a user at a first client machine 512 (CM-1). Then, the user of the first client machine 512 can interact with the form 510 to provide requested input data. After the requested input data has been submitted back to the workflow process manager 502, the workflow process manager 502 can determine a next task to be performed. In this embodiment, the next task is for the workflow process manager 502 to cause a first software robot 514 (SR-1) to be carried out (i.e., launched) on a second client machine 516 (CM-2). The first robotic agent 514 can then operate on the second client machine 516. Once the first robotic agent 514 completes, any outputs can be returned to the workflow process manager 502.

Thereafter, the workflow process manager 502 can determine a next task to be performed. In this embodiment, the next task is to present a form 518 (Form-2) to a user of a third client machine 520 (CM-3). The user at the third client machine 520 can then interact with the form 518 to provide input data. After the user submits the form 518, the input data can be provided to the workflow process manager 502. The workflow process manager 502 can then determine a next task to be performed. In this embodiment, the next task is for the workflow process manager 502 to cause a second software robot 522 (SR-2) to be carried out on a fourth client machine 524 (CM-4). When the second robotic agent 522 completes its processing, any outputs can be returned back to the workflow process manager 502. Thereafter, if there are no additional tasks to be carried out according to the workflow process 504 being performed, then the workflow process manager 502 notes that the workflow process 504 has been completed.

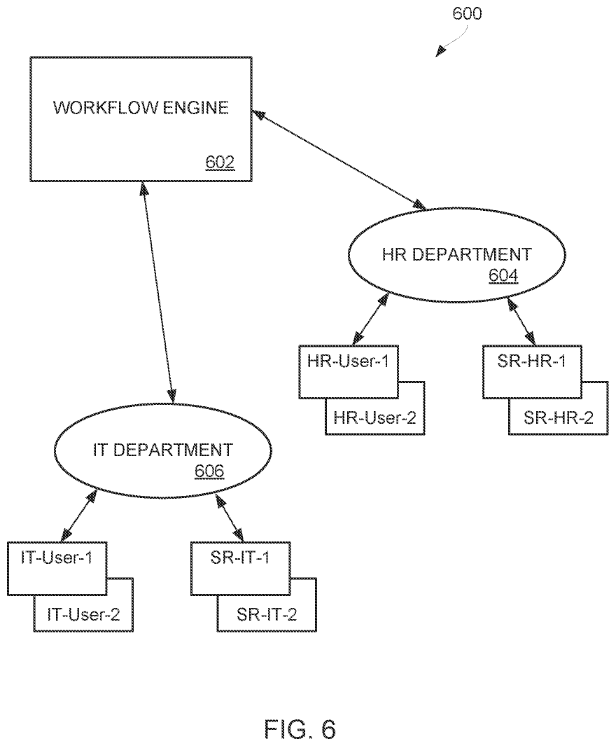

FIG. 6 is a block diagram of a distributed workflow process 600 according to one embodiment. The distributed workflow process 600 includes a workflow engine 602 that interacts with a Human Resources (HR) department 604 as well as with an Information Technology (IT) department 606. The workflow engine 602 can carry out a particular automation workflow process. In doing so, some interactions requested by the automation workflow process would be directed to the HR department 604 and other actions would be directed to the IT department 606. The sequencing of the automation workflow process and the decision to utilize resources (e.g., humans or computing devices or software robots) at either the HR department 604 or the IT department 606 would be controlled and detailed by the particular automation workflow process.

The HR department 604 can be associated with a team of users to the HR department 604. For example, as illustrated in FIG. 6, the team associated with the HR department 604 can include two distinct users, denoted as HR-user-1 and HR-user-2. These users are available within the HR department 604 to complete form tasks in an automation workflow process. For example, a form task can seek input from one of the users within the team associated with the HR department. Additionally, the HR department 604 can include a pool of programming resources, such as software robots that can be performed on computing devices associated with or authorized for use by the HR department 604. As illustrated in FIG. 6, the pool of programming resources available to the HR department 604 can include a first software robot and a second software robot, denoted SR-HR-1 and SR-HR-2, respectively.

The IT department 606 can similarly be associated with a team of users to the IT department 606. For example, as illustrated in FIG. 6, the team associated with the IT department 606 can include two distinct users, denoted as IT-user-1 and IT-user-2. These users are available within the IT department 606 to complete form tasks in an automation workflow process. For example, a form task can seek input from one of the users within the team associated with the IT department. Additionally, the IT department 604 can include a pool of programming resources, such as software robots that can be performed on computing devices associated with or authorized for use by the IT department 606. As illustrated in FIG. 6, the pool of programming resources available to the IT department 606 can include a first robotic software robot and a second software robot, denoted SR-IT-1 and SR-IT-2, respectively.

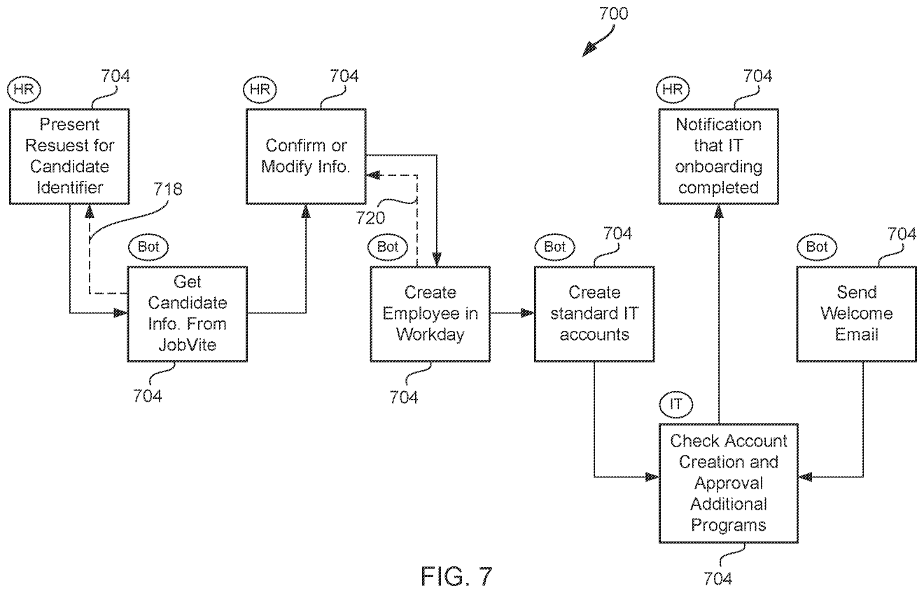

FIG. 7 is a block diagram of an employee onboarding workflow process 700 according to one embodiment. The employee onboarding workflow process 700 automates onboarding of a new employee across multiple departments of an organization. The onboarding workflow process 700 incorporates human tasks, robotic tasks, data exchange amongst tasks, and conditional logic. The onboarding workflow process 700 is an automation workflow process that can be carried out by a workflow process platform, such as the workflow process platform 104 illustrated in FIG. 1.

The onboarding workflow process 700 includes a workflow process description that describes the series of tasks associated with the process as well as inputs and outputs with respect to those tasks. The workflow process description can also include conditional logic to evaluate data received or produced by a task and/or irregular events.

The onboarding workflow process 700 can begin with an initial task, namely, a first HR team task 702. The first HR team task 702 is a human task that is directed to a member of the HR team to provide a user input. In this case, the user input is for a candidate identifier for the new employee. In one implementation, the first HR team task 702 can present a form on a display device associated with a client computer of the member of the HR team. The member of the HR team can then interact with the form to input the candidate identifier of the new employee. The form being displayed can also include a submit button that allows the member of the HR team to submit the candidate identifier back to the workflow process platform. At this point, the first HR team task 702 is deemed completed.

Next, the onboarding workflow process 700 can be consulted to determine a next task to be performed. In the case of the onboarding workflow process 700, following the first HR team task 702, a first robotic task 704 is to be performed. The first robotic task 704 identifies a particular software robot, i.e., software processing agent, that is to be performed. The onboarding workflow process 700 can also specify inputs to the first robotic task 704 and/or outputs from the first robotic task 704. In this embodiment, the first robotic task 704 can operate to cause the particular software robot to automatically retrieve known candidate information from an employee tracking and recruiting software system, such as JobVite™. In such case, the retrieved candidate information can be provided to the workflow process platform.

Following the completion of the first robotic task 704, the next task to be carried out according to the employee onboarding workflow process 700 is a second HR team task 706. The second HR team task 706 is a human task that is directed to a member of the HR team to confirm or modify the candidate information that was retrieved by the first robotic task 704. In one implementation, the second HR team task 706 can present a data entry form on a display device associated with a client computer of the user of the HR team, where the data entry form is populated with the candidate information that was retrieved by the first robotic task 704. The member of the HR team can then view the candidate information that is populated within the data entry form to either confirm or modify such information. Once the member of the HR team has completed their review, the member can submit the data entry form as confirmed or modified back to the workflow process platform. At this point, the second HR team task 706 is deemed completed.

According to the on boarding workflow process 700, after completion of the second HR team task 706, a second robotic task 708 can be performed. The second robotic task 708 identifies a particular software robot, i.e., software processing agent, that is to be performed. The onboarding workflow process 700 can also specify inputs to the second robotic task 708 and/or outputs from the second robotic task 708. In this embodiment, the second robotic task 708 can operate to cause the particular software robot to automatically create one or more employee records in a payroll management system, such as Workday™. Once the employee records have been successfully established, the second robotic task 708 is deemed completed.

Thereafter, after completion of the second robotic task 708, a third robotic task 710 can be performed. The third robotic agent task 710 identifies a particular software robot, i.e., software processing agent, that is to be performed. The onboarding workflow process 700 can also specify inputs to the third robotic task 710 and/or outputs from the third robotic task 710. In one implementation, the third robotic task 710 can operate to cause the particular software robot to automatically create one or more computer accounts in an enterprise computer system for use by the new employee. Once the computer accounts have been successfully established, the third robotic task 710 is deemed completed. Note that, while the second robotic agent task 708 is likely performed on a computing device affiliated with the HR department, the third robotic task 710 is likely performed on a computing device affiliated with the IT department.

Next, according to the onboarding workflow process 700, the next task to be carried out by the employee onboarding workflow process is a first IT team task 712. The first IT team task 712 is a human task that is directed to a member of the IT team to confirm account creation as well as approve any special programs (or applications) that are to be provided to the new employee. In one implementation, the first IT team task 712 can present a form on a display device associated with a client computer of a member of the IT team. The member of the IT team can then review account creation information that is presented in the form, and can also potentially interact with the form to designate or select any special applications/programs to be provided to the new employee. Once the member of the IT team has completed their review and provided any inputs (e.g., selections) with respect to the form, the member can submit the form to the workflow process platform. At this point, the first IT team task 712 is deemed completed.

Finally, according to the onboarding workflow process 700, following the first IT team task 712, two different tasks can be carried out. These two tasks include a third HR team task 714 and a fourth robotic task 716. These two tasks can be carried out in series or in parallel. The third HR team task 714 is a human task that is directed to the HR team home to notify them that the IT department has completed its IT related onboarding efforts for the new employee. The fourth robotic task 716 identifies a particular software robot, i.e., software processing agent, that is to be performed. The fourth robotic task 716 can operate to automatically send a welcome email to the new employee. After the completion of the fourth robotic task 716 and also the third HR team task 714, the employee onboarding workflow process 700 is completed.

The workflow process platform in carrying out the onboarding workflow process 700 (or any other workflow processes) can not only manage process flow and data flow between tasks, but also provide data storage (e.g., variable storage), fallback situations, error checking and exception handling. By embedding conditional logic in an automated workflow process, such as the employee onboarding workflow process 700, the workflow process platform is able to handle fallback situations, error checking and exception handling. As one example, the onboarding workflow process 700 can include a fallback situation 718, such as logic (e.g., conditional logic) to cause the process flow to return back to the first HR team task 702 if the first robotic task 704 determines that the candidate identifier provided by the first HR team task 702 is not recognized by the particular software robot used by the first robotic task 704. In such an example, the first HR team task 702 can require a HR team member to recheck and again enter a candidate identifier for the new employee.

As another example, the onboarding workflow process 700 can include exception handling 720, such as logic (e.g., conditional logic) to cause the process flow to return back to the second HR team task 706 if the second robotic task 708 determines that the particular software robot used by the second robotic task 708 produced an exception during its operation. Using the logic embedded in the onboarding workflow process 700, process flow can return back to the second HR team task 706 where the exception can be recognized and handled with exception processing embedded in the onboarding workflow process 700.

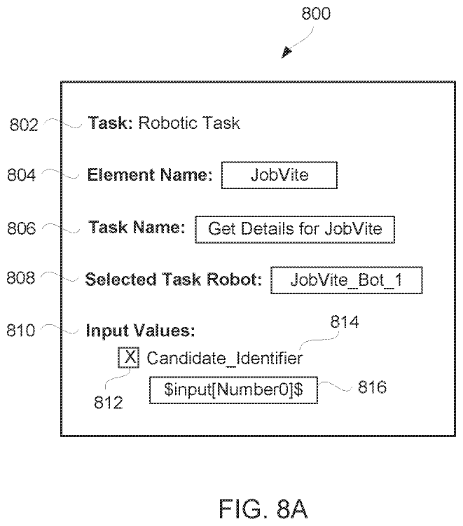

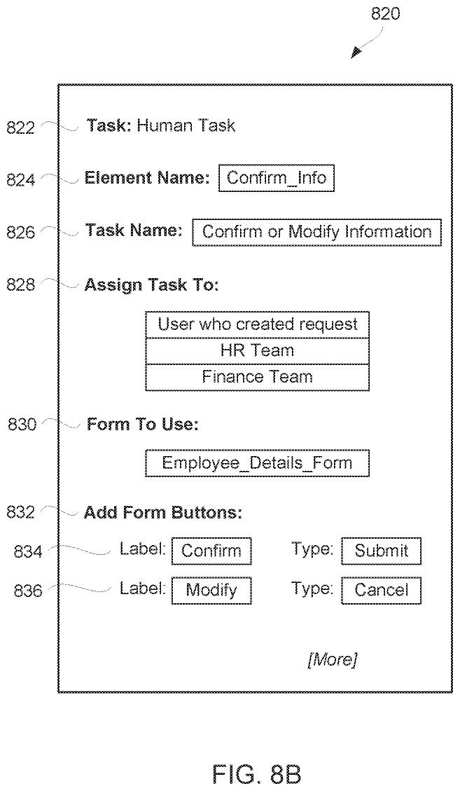

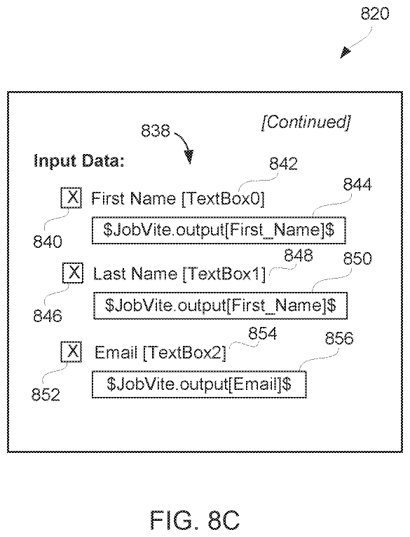

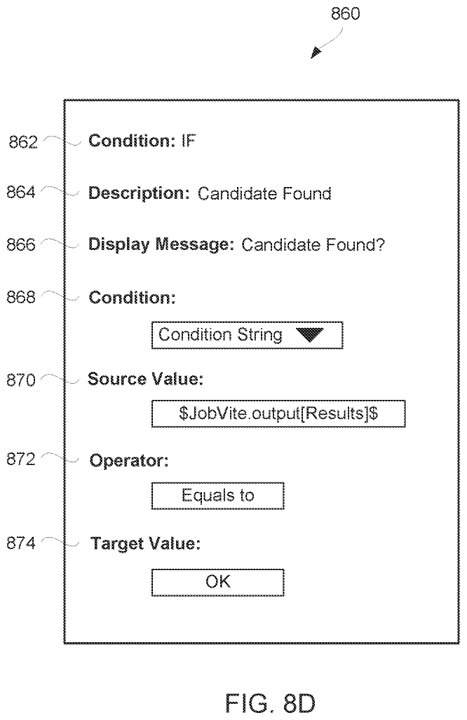

FIGS. 8A-8D are exemplary screenshots of configuration screens that can be used to configure operation of an automation workflow process, according to one embodiment.

FIG. 8A is a screenshot of a robotic task configuration screen 800 according to one embodiment. The robotic task configuration screen 800 is a screen that can be presented on a display screen associated with a computing device, namely, the computing device associated with a user that is creating an automation workflow process. The robotic task configuration screen 800 includes a task indicator 802, an element name 804, a task name 806, a selected task robot 808, and input values 810.

The task indicator 802, in this example, indicates that the involved task being configured is a robotic task, which is an automated task carried out by a software robot. The element name 804 provides a name for the task within an automated workflow process. In this example, the element name is “JobVite” which is a job-based service provider that is being utilized. The task name 806 provides a descriptive name for the task being carried out by the software robot. In this example, the task name 806 provided by a user interacting with the robotic task configuration screen 800 is “Get Details form JobVite”. The selected task robot 808 provides an identifier for the particular software robot that is to be utilized when the robotic task is initiated. In this example, the selected task robot 808 is identified as “JobVite_Bot_1”. The input values 810 being identified in robotic task configuration screen 800 vary depending upon the type of software robot and its operations. In this particular example, one input for the robotic task is a possible input and selectable by a checkbox 812. If the checkbox 812 is “checked,” then the Candidate_Identifier 814, which is the input sought by the software robot, can be specified. To do so, the robotic task configuration screen 800 can include a text box 816 where a variable name can be specified for use with the software robot as the Candidate_Identifier 814. As an example, a prior human task could have been performed to obtain, from a user, a candidate identifier to be processed. Since the obtained candidate identifier is represented as a variable, the variable can be specified in text box 816. In this example, the variable name placed in the text box 816 is “$input[Number0]$”, which links the output of the prior human task to the input of the subsequent robotic task. As such, in general, any output value from a prior task of an automation workflow process is able to be specified and utilized in a subsequent task.

FIGS. 8B and 8C are screenshots of a human task configuration screen 820 according to one embodiment. FIG. 8B depicts the first part of the human task configuration screen 820 and FIG. 8C depicts the second part of the human task configuration screen. The human task configuration screen 820 is, for example, a graphical user interface that is presented on a display screen so that a user can configure the associated human task. In this example, the human task when executed presents a graphical user interface on a display screen so that a member of a team of an organization, such as an HR team, can confirm employee data being presented by the graphical user interface.

As shown in FIG. 8B, the human task configuration screen 820 includes a task identifier 822, an element name 824, a task name 826, an assignment request 828, and a form identifier 830. The task identifier 822 notes that the involved task is a human task to be carried out by a person. The element name 824 specifies the name of the element for the task within the automation workflow process. In this example, the element name 824 is denoted “Confirm Info”. The task name 826 provides a descriptive name for the task that can be displayed, which in this case is “Confirm or Modify Information”. The assignment request 828 permits the process workflow platform to assign the involved human task to an individual or group. For example, the task can is be assigned to a user who initially created the request, or to a member of a team (e.g., HR team or IT team). The assignment request 828 may, in one embodiment, be presented in list form for a user to select or, in another embodiment, may be manually entered by the user. The form identifier 830 can be used to specify a form name that is to be utilized by the human task. In this example, the form name is “Employee_Details_Form”. In this example, the identified form is an electronic form that is presented as or within a graphical user interface to the assigned individual or group when this human task is performed.

The human task configuration screen 820 also includes a button option 832 to add one or more buttons (i.e., user controls) to the form. In this example, two buttons have been added to the form. A first button 834 is labeled “Confirm” and has a type “Submit”, and a second button has a label “Modify” and has a type “Cancel”. These buttons 834 and 836 can be added to the existing form such that the user can inform the process workflow platform as to whether the employee information has been confirmed or whether it should be modified.

As shown in FIG. 8C, the human task configuration screen 820 can also specify input data 838 to be utilized with the associated form of the human task. In this example, the input data 838 for the form can optionally include first name, last name and email for the employee. The human task configuration screen 820 includes a selector 840, a first name designator 842, and a variable name 844 that is to correspond to the first name designator. In this example, the variable name 844 is specifying an output variable pertaining to a first name from the earlier robotic task that interacts with the JobVite service provider. The human task configuration screen 820 also includes a selector 846, a last name designator 848, and a variable name 850 that is to correspond to the last name designator. In this example, the variable name 850 is specifying an output variable pertaining to a last name from the earlier robotic task that interacts with the JobVite service provider. The human task configuration screen 820 also includes a selector 852, an email designator 854, and a variable name 856 that is to correspond to the email designator. In this example, the variable name 856 is specifying an output variable pertaining to an email address from the earlier robotic task that interacts with the JobVite service provider. Hence, the human task, when performed, can present in a user interface (e.g., electronic form) one or more variables (e.g., text strings) that were obtained and output from the earlier robotic task.

FIG. 8D is a screenshot of a condition configuration screen 860 according to one embodiment. The condition configuration screen 860 can be utilized to enable a user to specify conditional logic for an automation workflow process. The conditional logic being specified can also be referred to as a conditional task. The conditional logic can be used to provide conditional branching in processing flow of an automation workflow process. In general, the conditional logic can be based on a condition such as if-than-else which be performed with strings, numbers, or Boolean inputs.

The condition configuration screen 860 includes a condition identifier 862, a description identifier 864, and a display message 866. The condition identifier 862, in this example, specifies that the conditional logic is a “IF” condition. The description identifier 864 indicates that a description for the conditional logic can be “Candidate Found”. The display message 866 can specify a message during performance of the condition task. In this example, the display message 866 is “Candidate Found?”.

Still further, the condition configuration screen 860 can provide a condition indicator 868, a source value 870, a logical operator 872, and a target value 874. In this example, the condition indicator 868 is indicating that the involved condition is premised on a string value. The source value 870 can specify what value is being conditionally checked. In this example, the source value being checked is an output result from a software robot. Specifically, the output of the JobVite robotic task (which would be a prior task) is used as a source input value for the conditional logic of the automation workflow process. Hence, the source value 870 can specify a variable as output from the JobVite robotic task. The operator indicator 872 specifies the logical operation to be utilized. In this example, the logical operator is “Equals to” but various other logical operators can be used (e.g., less than, greater than, less than or equal to, greater than or equal to). Finally, the target value 874 specifies the value to which the logical operation is to be compared. In this example, the target value 874 is “OK”. Hence, if the variable output from the JobVite robotic task is equal to the target value “OK”, then during performance of the IF condition associated with the conditional logic (i.e., condition task within the automation workflow process) the automation workflow process would proceed to perform tasks in the associated branch.

As noted above, conditional logic can be used to provide conditional branching in processing flow of an automation workflow process. In one embodiment, the workflow process platform can use ternary logic operations. Here, in evaluating logical conditions, processes may result in a true, false or missing. A result is “missing” when a condition cannot be fully evaluated because some input is missing. For example, need data may be unavailable because the workflow executed in a different branch so the data is missing; some error occurred in a task so the data was not received; or due to changes to task designs that result in error (e.g., variable reference is invalid). To provide a more robust operation of the workflow process platform, an automation workflow process can handle the missing data gracefully such that the automation workflow process can normally continue. A missing data item can be handled using ternary logic. For example, for a condition:
result_from_step1==4)∥(result_from_step2==result_from_step3)

If result_from_step1 is missing, then the whole (result_from_step1==4) is considered missing, and equivalently if result_from_step2 or result_from_step3 is missing, then the whole (result_from_step2==result_from_step3) is considered missing. Each part of the condition can produce a ternary result, and then the parts can be combined using the logic tables below to produce the final result. If the statement produces a true value, then the commands within the condition will be executed; if the statement produces a missing or false value, the interpreter moves to the next else-if and evaluates that condition. If all of the else-if's fail, then eventually the else will execute.

Logic tables for ternary logic (i.e., three valued logic) are below, and can be used when combining sequences of logical statements.

Ternary-AND (&&) Table

| | TRUE | FALSE | MISSING |
|---|---|---|---|
| TRUE | TRUE | FALSE | MISSING |
| FALSE | FALSE | FALSE | MISSING |
| MISSING | MISSING | MISSING | MISSING |

Ternary-OR (II) Table

| | TRUE | FALSE | MISSING |
|---|---|---|---|
| TRUE | TRUE | TRUE | TRUE |
| FALSE | TRUE | FALSE | FALSE |
| MISSING | TRUE | FALSE | MISSING |

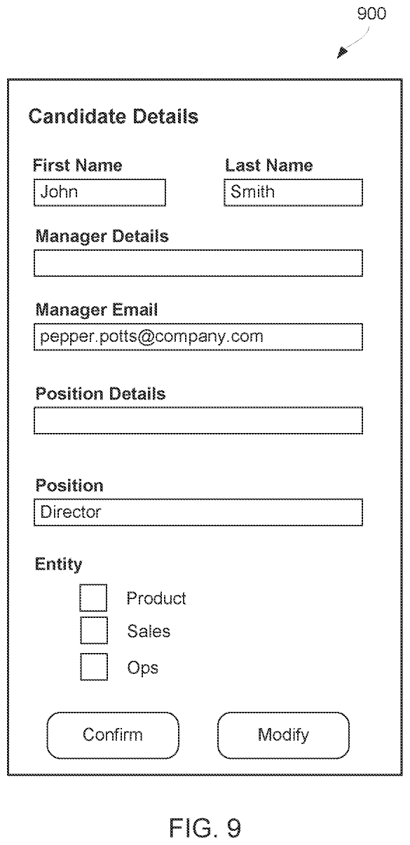

FIG. 9 is s screenshot of an exemplary form 900 that can be present to a person in context of a human task, according to one embodiment. In this form 900, candidate information can be presented to a HR team member, whom can the confirm or modify the presented information. This form 900 is, for example, suitable for use as the form presented by the second HR team task 706 of the onboarding workflow process 700 illustrated in FIG. 7.

In an automated workflow process, such the onboarding workflow process 700 illustrated in FIG. 7, an example of a definition (i.e., description) that can be produced by the workflow process flatform, according to one exemplary embodiment, is as contained in U.S. Patent Provisional Application No. 63/285,081, filed Dec. 1, 2021, and entitled “ROBOTIC PROCESS AUTOMATION FOR MANAGING HUMAN, ROBOTIC AND EXTERNAL TASKS,” which is hereby incorporated herein by reference, see Appendix A thereof, which is included or incorporated herein into this document. Notable, in this exemplary embodiment, the automated workflow process for employee onboarding is described in a computer-readable manner (e.g., JSON), such that the process can be implemented by one or more computing devices supporting the workflow process platform.

Another aspect of embodiments of the invention provides for an automation workflow process that can include interaction with one or more external applications. The one or more external applications are external to the workflow process platform and separate therefrom. Typically, the one or more external applications are located on computing devices of third-parties separate from computing devices of the party utilizing the automation workflow platform.

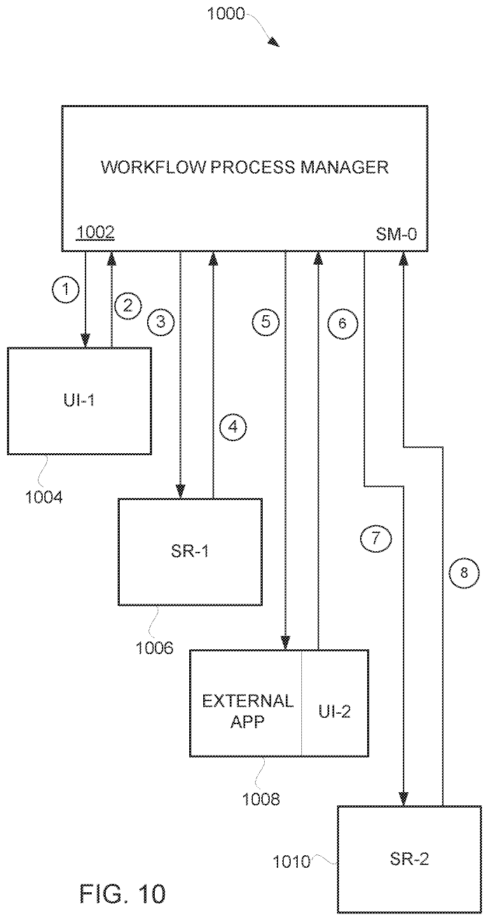

FIG. 10 illustrates a block diagram of an automation workflow process 1000 according to one embodiment. The automation workflow process 1000 includes a workflow process manager 1002 that is capable of performing (e.g., launching) the automation workflow process 1000. The workflow process manager 1002 can, in one implementation, be included within the workflow process platform 104 illustrated in FIG. 1. The automation workflow process 1000 that is to be performed can, for example, be created by the workflow process platform 104 illustrated in FIG. 1 or the workflow process generator 202 illustrated in FIG. 2. In one implementation, the workflow process manager 1002 operates on a server machine (SM-0), such as the RPA server 102 illustrated in FIG. 1. More generally, the workflow process manager 1002 can operate on any computing device.

The workflow process manager 1002 can be configured to carry out the automation workflow process 1000. In doing so, the workflow process manager 1002 can interact with various different computing devices where robotic agents and/or software applications and/or humans (e.g., users or teams of users) can participate in performing portions of the automation workflow process 1000.

The automation workflow process 1000 to be carried out can be described by a workflow process definition. The workflow process definition is typically either a computer readable structured description of the processing to be carried out or executable code derived therefrom. The workflow process definition can be stored in a repository or data storage accessible to the workflow process manager 1002.

In one embodiment, such as illustrated in FIG. 10, the automation workflow process 1000 can include use of a first user interface (UI-1) 1004, a first software robot (SR-1) 1006, an external application 1008 (including or supporting user interface (UI-2)), and a second software robot (SR-2) 1010.

In this particular embodiment, the automation workflow process 1000 orchestrates the interrelationship (e.g., sequencing and coordination) between the first user interface (UI-1), the first software robot (SR-1), the external application, the user interface (UI-2), and the second software robot (SR-2). The interrelationship of these components is exemplary and depicted by a series of eight steps. The workflow process manager 1002, in a first step, can cause the first user interface (UI-1) 1004 to be launched, and then, in a second step, waits on receipt of a response to the first user interface (UI-1) by way of a human.

Next, the workflow process manager 1002, in a third step, can cause a first software robot (SR-1) to be activated, and then, in a fourth step, waits on receipt of resultant data when the first software robot completes its execution. Next, the workflow process manager 1002, in a fifth step, can send a request to an external application 1008. The request to the external application 1008 can include input data that is used by the external application 1008 for its processing. Once the external application 1008 has completed its processing using the input data, the second user interface (UI-2) can be launched in a sixth step. The second user interface (UI-2) can be rendered, in one embodiment, by the external application 1008. In one implementation, the second user interface (UI-2) can include resultant data from the external application 1008 presented within an iFrame. The second user interface (UI-2) can also include one or more user input controls (e.g., buttons, selectors, etc.) provided by the automation workflow process 1000, such as in addition to the resultant data presented within the iFrame. The second user interface (UI-2) can allow a human to confirm, supplement or alter the result data provided by the external application 1008. Thereafter, the resultant data (whether confirmed, supplemented or altered) can be provided to the workflow process manager 1002.

Finally, the workflow process manager 1002, in a seventh step, causes the second software robot (SR-2) to be activated. Then, in an eighth step, the workflow process manager 1002 waits on receipt of an indication that the second software robot (SR-2) completes its execution and/or data provided from the second software robot (SR-2).

Although this particular embodiment shown in FIG. 10 illustrates eight steps in a particular sequence and with respect to particular components, it should be understood that the number of components utilized, the ordering of the components, and the type of components can widely vary in different embodiments.

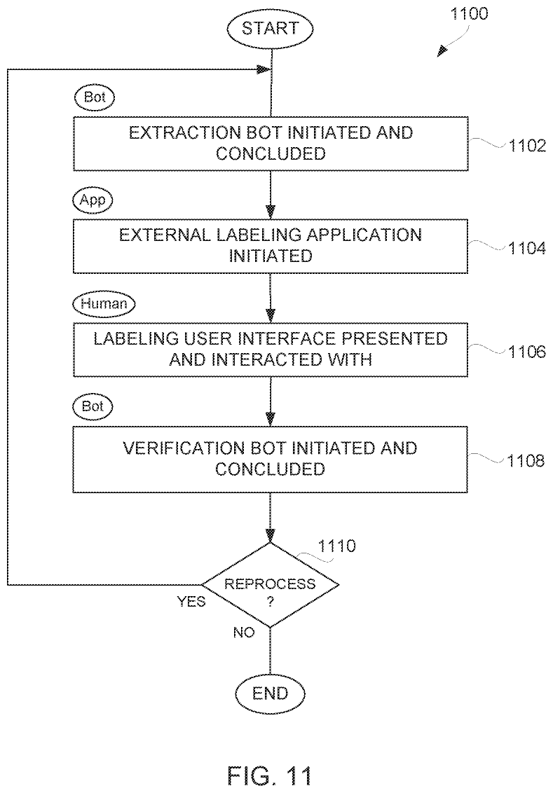

FIG. 11 illustrates a flow diagram of a document labeling workflow process 1100 according to one embodiment. The document labeling workflow process 1100 can be performed by the workflow process manager 1002 as one implementation of the document labeling workflow process 1100. The document labeling workflow process 1100 concerns a particular workflow associated with labeling of documents, such as business documents. In the document labeling workflow process 1100, documents can be labeled in an automated fashion but with the assistance or oversight of a human to ensure adequate quality of results.

The document labeling workflow process 1100 can initially activate an extraction bot 1102. The extraction bot 1102 is a software robot that can identify one or more documents that need to be labeled. Next, an external labeling application 1104 can be initiated by the document labeling workflow process 1100. The external labeling application 1104 is a software application that is external to the workflow process manager 1002. In one example, the external labeling application 1104 can provide Optical Character Recognition (OCR) data extraction and automated labeling of the one or more documents based on the data extracted. In doing so, the external labeling application 1104 can, in one embodiment, incorporate machine learning for enhanced quality.

Next, the document labeling workflow process 1100 can provide a labeling user interface 1106 to a human to allow for user input. User input can confirm the automated label provided by the external labeling application 1104 or can alter the automated label, or can cause the automated label to be rejected (and potentially cause another attempt at automated labeling). For example, the labeling of a document might pertain to a business's customer, and that labeling might include customer name and address. The automated labeling can have inaccuracies or errors, and the labeling user interface 1106 can allow user input to correct errors in such data.

After the human has provided the user input using the labeling user interface 1106, the document labeling workflow process 1100 can initiate a verification bot 1108. The verification bot 1108 is a software robot that can verify that each of the one or more documents to be labeled has been successfully labeled. Alternatively or additionally, the verification bot 1108 could, for example, check that automated or user-provided data is verified. As an example, an address can be verified to be a U.S. Postal Service recognized address.

The document labeling workflow process 1100 can also include a decision 1110 that determines whether any of the labels for the one or more documents should be reprocessed. When the decision 1110 determines that one or more of the documents should be reprocessed, then the document labeling workflow process 1100 can return to again initiate the verification bot 1108 for reprocessing, or alternatively to the external labeling application 1104 for reprocessing. Alternatively, when the decision 1110 determines that the one or more documents have been successfully labeled, the document labeling workflow process 1100 can end.

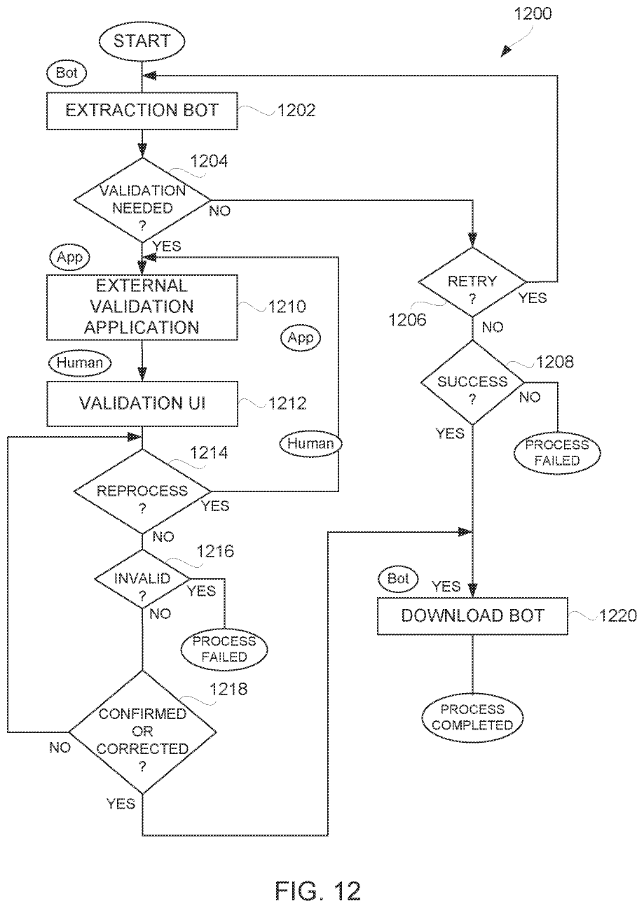

FIG. 12 illustrates a flow diagram of a data extraction workflow process 1200 according to one embodiment. The data extraction workflow process 1200 can be performed by the workflow process manager 1002 illustrated in FIG. 10 as one implementation of the data extraction workflow process 1200. The data extraction workflow process 1200 concerns a particular workflow associated with extracting data from images of documents, such as business documents. In the data extraction workflow process 1200, data can be recognized and extracted from documents in an automated fashion but with the assistance of a human to ensure adequate quality of results.

The data extraction workflow process 1200 can initially activate an extraction bot 1202. The extraction bot 1202 is a software robot then can extract data from a document. As an example, the extraction bot 1202 can use Optical Character Recognition (OCR) data extraction. As another example, the extraction bot 1202 can also use one or more trained machine learning models, via artificial intelligence, for better data extraction results. After the extraction bot 1202 has completed, a decision 1204 can determine whether validation of the extracted data is needed. For example, the extraction bot 1202 can provide a confidence or accuracy indication with respect to its data extraction, and then that indication can be examined to determine if validation is needed. For example, if the confidence or accuracy indication is below a minimum threshold level, then validation is needed.

When the decision 1204 determines that validation is not needed, a decision 1206 can determine whether automated extraction is to be retried. When the decision 1206 determines that automated extraction is to be retried, then the data extraction workflow process 1200 can return to the extraction bot 1202 to re-perform automated data extraction. On the other hand, when the decision 1206 determines that automated extraction need not be retried, a decision 1208 can determine whether the extraction bot 1202 completed its processing successfully. If the decision 1208 determines that the extraction bot 1202 did not complete successfully, the data extraction workflow process 1200 can end with the data extraction process having failed.

On the other hand, when the decision 1204 determines that further validation is to be performed, then an external validation application 1210 can be invoked by the data extraction workflow processed 1200. The external validation application 1210 is a software application that is external to the workflow process manager 1002. The external validation application 1210 can be a first-party application or a third-party application. The first-party application being provided by the same party as the workflow process platform, and the third-party application being a different party that the party providing the workflow process platform. In one example, the external validation application 1210 can be part of a data extraction engine, and in such case, the external validation application 1210 can render relevant data that is to be presented to a user using a validation user interface 1212.

The data extraction workflow processed 1200 includes the validation user interface 1212 that allows for user input from a user. User input can be used to further validate data extracted by the extraction bot 1202. For example, the external validation application 1210 is able to retrieve data relevant to a portion of the extracted data (by the extraction bot 1202) that is to be validated. The retrieved relevant data can then be provided to the validation user interface 1212 such that it can be presented to the user to provide validation. The user, by way of the validation user interface 1212 can then provide a manual validation. User input via the validation user interface 1212 can confirm (accept), reject (invalidate) or correct (edit) the extracted data from the automated validation.

Thereafter, depending upon the user input via the validation user interface 1212, the data extraction workflow process 1200 proceeds differently. In this regard, a decision 1214 determines whether to reprocess the data extraction and/or validation. When the decision 1214 determines that the data extraction and/or validation should be reprocessed, the data extraction workflow process 1200 can return to the processing by the external validation application 1210. In an alternative implementation (not illustrated), when the decision 1214 determines that the data extraction and/or validation should be reprocessed, the data extraction workflow processed 1200 could return to the extraction bot 1202. When the decision 1214 determines that the data extraction and/or validation need not be reprocessed, a decision 1216 can determine whether the user input has invalidated the data extraction. If the decision 1216 determines that the data extraction is invalid, then the data extraction work process 1200 ends with the data extraction processing having failed.

Additionally, when the decision 1216 determines that data extraction processing is valid, the decision 1218 can determine whether the extracted data has been confirmed or corrected. When the decision 1218 determines that the extracted data has been confirmed or corrected, a download bot 1220 can be activated. The download bot 1220 can download the extracted data that has been validated. The download bot 1220 can also be activated following the decision 1208 when the extraction bot 1202 is determined to have completed successfully. In either case, following the completion of the download bot 1220, the data extraction flow process 1200 is complete and ends with the data extraction being successful.

In one embodiment, the data extraction process associated with the workflow process platform can communicate with an application, such as the external validation application 1210, using an iFrame communication interface. An exemplary iFrame communication interface is contained in U.S. Patent Provisional Application No. 63/285,081, filed Dec. 1, 2021, and entitled “ROBOTIC PROCESS AUTOMATION FOR MANAGING HUMAN, ROBOTIC AND EXTERNAL TASKS,” which is hereby incorporated herein by reference, see Appendix C thereof. In one implementation, the iFrame communication interface can present (e.g., for the user) the data extracted by the external validation application 1210 within or in addition to the validation user interface 1212.

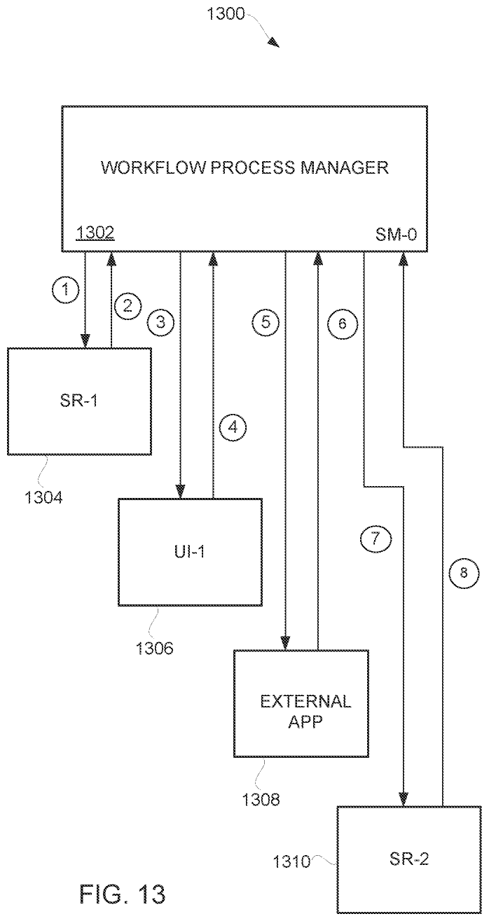

FIG. 13 illustrates a block diagram of an automation workflow process 1300 according to one embodiment. The automation workflow process 1300 includes a workflow process manager 1302 that is capable of performing (e.g., launching) the automation workflow process 1300. The workflow process manager 1302 can, in one implementation, be included within the workflow process platform 104 illustrated in FIG. 1. The automation workflow process 1300 that is to be performed can, for example, be created by the workflow process platform 104 illustrated in FIG. 1 or the workflow process generator 202 illustrated in FIG. 2. In one implementation, the workflow process manager 1302 operates on a server machine (SM-0), such as the RPA server 102 illustrated in FIG. 1. More generally, the workflow process manager 1302 can operate on any computing device.

The workflow process manager 1302 can be configured to carry out the automation workflow process 1300. In doing so, the workflow process manager 1302 can interact with various different computing devices where robotic agents and/or software applications and/or humans (e.g., users or teams of users) can participate in performing portions of the automation workflow process 1300.

The automation workflow process 1300 to be carried out can be described by a workflow process definition. The workflow process definition is typically either a computer readable structured description of the processing to be carried out or executable code derived therefrom. The workflow process definition can be stored in a repository or data storage accessible to the workflow process manager 1302.

In one embodiment, such as illustrated in FIG. 13, the automation workflow process 1300 can include use of a first software robot (SR-1) 1304, a first user interface (UI-1) 1306, an external application 1308, and a second software robot (SR-2) 1310.

In this particular embodiment, the automation workflow process 1300 orchestrates the interrelationship (e.g., sequencing and coordination) between the first software robot (SR-1), the first user interface (UI-1), the external application, and the second software robot (SR-2). The interrelationship of these components is exemplary and depicted by a series of eight steps. The workflow process manager 1302, in a first step, can cause the first software robot (SR-1) to be activated, and then, in a second step, waits on receipt of resultant data when the first software robot (SR-1) completes its execution. Next, in a third step, the workflow process manager 1302 can cause the first user interface (UI-1) 1306 to be launched, and then, in a fourth step, waits on receipt of a response to the first user interface (UI-1) by way of a human. The first user interface (UI-1) can include one or more user input controls (e.g., buttons, selectors, etc.) provided by the automation workflow process 1300 to allow a human to provide a user input.

Next, the workflow process manager 1302, in a fifth step, can send a request to an external application 1308. The request to the external application 1308 provides input data that is used by the external application 1308 for its processing. Once the external application 1308 has completed its processing using the input data, resultant data from the external application can be provided to the workflow process manager 1302, in a sixth step. Finally, the workflow process manager 1302, in a seventh step, causes the second software robot (SR-2) to be activated. Then, in an eighth step, the workflow process manager 1302 waits on receipt of an indication that the second software robot (SR-2) completes its execution and/or data provided from the second software robot (SR-2).

Although this particular embodiment shown in FIG. 13 illustrates eight steps in a particular sequence and with respect to particular components, it should be understood that the number of components utilized, the ordering of the components and the type of components can widely vary in different embodiments.

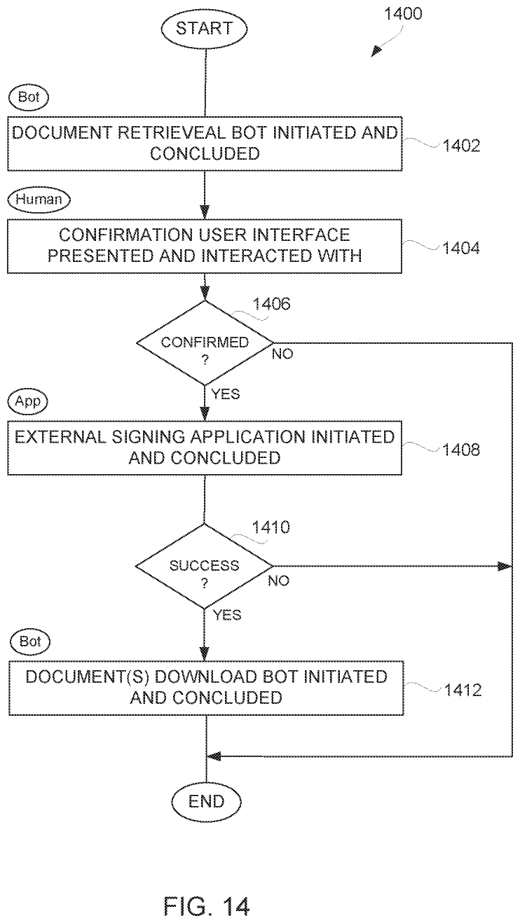

FIG. 14 illustrates a flow diagram of a document signing workflow process 1400 according to one embodiment. The document signing workflow process 1400 can be performed by the workflow process manager 1302 illustrated in FIG. 13 as one implementation of the automation workflow process 1300. The document signing workflow process 1400 concerns a particular workflow associated with signing of documents, such as business documents. In the document signing workflow process 1400, documents can be signed in an automated fashion but with the assistance of a human to ensure reliability.

The document signing workflow process 1400 can activate a document retrieval bot 1402. By way of a user interface, a user might may have previously identified the document to be retrieved, such step could also be included in the document signing workflow process 1400, although not shown in FIG. 14. The retrieval bot 1402 is a software robot that can retrieve one or more documents that need to be signed. Next, the document signing workflow process 1400 can provide a confirmation user interface 1404 to a human to allow for user input. User input can confirm that the retrieved one or more documents are indeed the documents ready to be signed.

After the human has provided the user input using the confirmation user interface 1404, a decision 1406 can determine whether the user has confirmed readiness to sign. If the user cannot confirm readiness, the document signing workflow process 1400 can end without any document signing. If the user is able to confirm readiness, the document signing workflow process 1400 can invoke an external signing application 1408. The external signing application 1408 is a software application that is external to the workflow process manager 1302. In one example, the external signing application 1408 can be a cloud-based service that facilitates electronic signing of documents.

After the external signing application 1408 has completed, a decision 1410 can determine whether the document signing was successful. Typically, the external signing application 1408 would inform the document signing workflow process 1400 whether the document signing was successful. When the decision 1410 determines that the document signing was successful, a download bot 1412 can be activated. The download bot 1412 can then download the one or more signed documents that have been signed. Following the completion of the download bot 1412, the data signing workflow process 1400 is complete and ends with the data signing being successful. Alternatively, if the decision 1410 determines that the document signing was unsuccessful, then the data signing flow process 1400 is complete and ends with the data signing being unsuccessful.

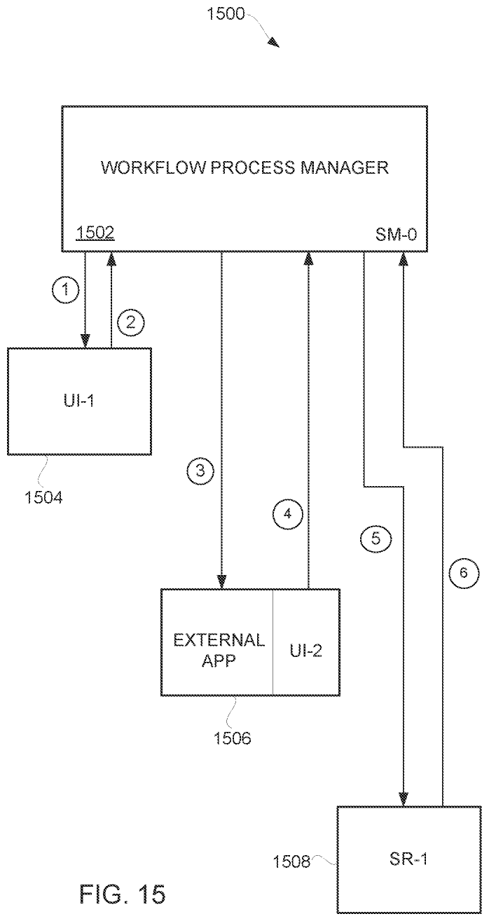

FIG. 15 illustrates a block diagram of an automation workflow process 1500 according to one embodiment. The automation workflow process 1500 includes a workflow process manager 1502 that is capable of performing (e.g., launching, monitoring, controlling, etc.) the automation workflow process 1500. The workflow process manager 1502 can, in one implementation, be included within the workflow process platform 104 illustrated in FIG. 1. The automation workflow process 1500 that is to be performed can, for example, be created by the workflow process platform 104 illustrated in FIG. 1 or the workflow process generator 202 illustrated in FIG. 2. In one implementation, the workflow process manager 1502 operates on a server machine (SM-0), such as the RPA server 102 illustrated in FIG. 1. More generally, the workflow process manager 1502 can operate on any computing device.

The workflow process manager 1502 can be configured to carry out the automation workflow process 1500. In doing so, the workflow process manager 1502 can interact with various different computing devices where robotic agents and/or software applications and/or humans (e.g., users or teams of users) can participate in performing portions of the automation workflow process 1500.

The automation workflow process 1500 to be carried out can be described by a workflow process definition. The workflow process definition is typically either a computer readable structured description of the processing to be carried out or executable code derived therefrom. The workflow process definition can be stored in a repository or data storage accessible to the workflow process manager 1502.

In one embodiment, such as illustrated in FIG. 15, the automation workflow process 1500 can include use of a first user interface (UI-1) 1504, an external application 1506 (including or supporting user interface (UI-2)), and a first software robot (SR-1) 1508.

In this particular embodiment, the automation workflow process 1500 orchestrates the interrelationship (e.g., sequencing and coordination) between the first user interface (UI-1), the external application (with user interface (UI-2)), and the first software robot (SR-1). The interrelationship of these components is exemplary and depicted by a series of six steps. The workflow process manager 1502, in a first step, can cause the first user interface (UI-1) 1504 to be launched, and then, in a second step, waits on receipt of a response to the first user interface (UI-1) by way of a human.

Next, the workflow process manager 1502, in a third step, can send a request to an external application 1506. The request to the external application 1506 provides input data that is used by the external application 1506 for its processing. Once the external application 1506 has completed its processing using the input data, the second user interface (UI-2) can be launched in a fourth step. The second user interface (UI-2) can be rendered, in one embodiment, by the external application 1506. In one implementation, the second user interface (UI-2) can include resultant data from the external application 1506, such as for example presented within an iFrame. The second user interface (UI-2) can also include one or more user input controls (e.g., buttons, selectors, etc.) provided by the automation workflow process 1500, such as in addition to the resultant data presented within the iFrame. The second user interface can allow a human to confirm, supplement or alter the result data provided by the external application 1506. Thereafter, the resultant data (whether confirmed, supplemented or altered) can be provided to the workflow process manager 1502.

Finally, the workflow process manager 1502, in a fifth step, causes the second software robot (SR-2) to be activated. Then, in a sixth step, the workflow process manager 1502 waits on receipt of an indication that the second software robot (SR-2) completes its execution and/or data provided from the second software robot (SR-2).

Although this particular embodiment shown in FIG. 15 illustrates six steps in a particular sequence and with respect to particular components, it should be understood that the number of components utilized, the ordering of the components and the type of components can be altered in different embodiments.

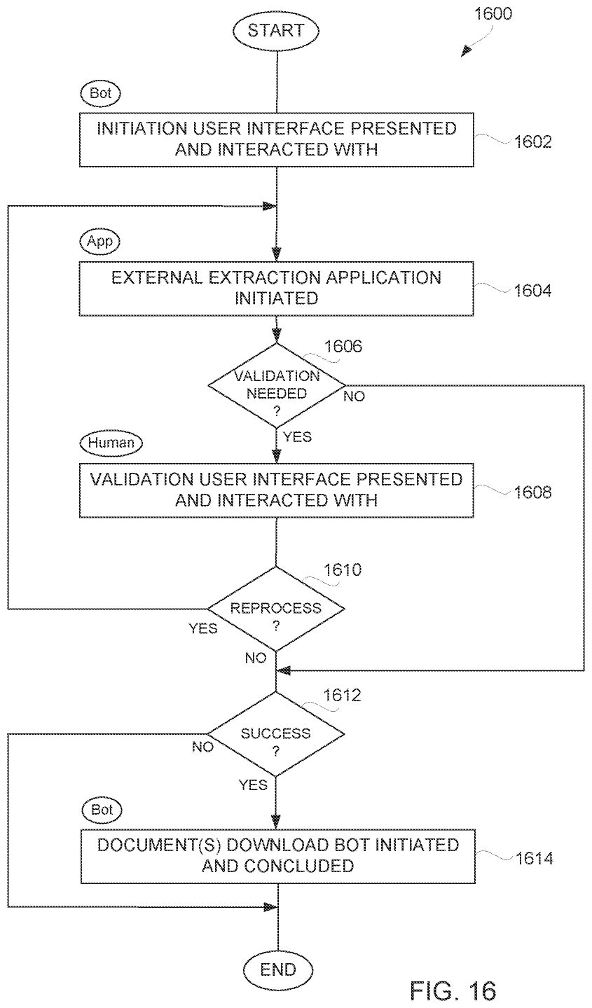

FIG. 16 illustrates a flow diagram of a data extraction workflow process 1600 according to one embodiment. The data extraction workflow process 1600 can be performed by the workflow process manager 1502 illustrated in FIG. 15 as one implementation of the automation workflow process 1500. The data extraction workflow process 1600 concerns a particular workflow associated with extracting data from images of documents, such as business documents. In the data extraction workflow process 1600, data can be recognized and extracted from documents in an automated fashion but with the assistance of a human to ensure adequate quality of results.

The data extraction workflow process 1600 can initially present an initiation user interface (UI) 1602. For example, the initiation UI can present a user interface to a user that allow the user to identify one or more documents to be processed.

Next, an external extraction application 1604 can be invoked by the data extraction workflow processed 1600. The external extraction application 1604 can, for example, be a software application that is external to a workflow process manager (e.g., workflow process manager 1502). The external extraction application 1604 can be a first-party application or a third-party application. The first-party application being provided by the same party as the workflow process platform, and the third-party application being a different party that the party providing the workflow process platform.

After the external extraction application 1604 has performed its data extraction, a decision 1606 can determined whether user validation is needed. When the decision 1606 determines that user validation is needed, then a validation user interface 1608 can be presented.

The validation user interface 1608 allows for user input from a user. User input can be used to further validate data extracted by the external extraction application 1604. For example, the external extraction application 1604 is able to extract data that is to be validated. The extracted data can then be provided to the validation user interface 1608 such that it is presented to the user to provide validation. The user, by way of the validation user interface 1608 can then provide a manual validation. User input via the validation user interface 1608 can confirm (accept), reject (invalidate) or correct (edit) the extracted data from the automated validation.

Thereafter, depending upon the user input via the validation user interface 1608, the data extraction workflow process 1600 proceeds differently. In this regard, a decision 1610 can determine whether to reprocess the data extraction. When the decision 1610 determines that the data extraction should be reprocessed, the data extraction workflow process 1600 can return to the processing by the external extraction application 1604.

Alternatively, when the decision 1610 determines that the data extraction has been sufficiently extracted and/or validated, the data extraction workflow process 1600 can proceed to a decision 1612. Also, when the decision 1606 has determined that user validation is not needed, then the data extraction workflow process 1600 can proceed directly to the decision 1612. The decision 1612 can determine whether the data extraction has been successful. When the decision 1612 determines that the data extraction has been successful, a download bot 1614 can be activated. The download bot 1614 can download the extracted data that has been validated. Following the completion of the download bot 1614, the data extraction workflow process 1600 is complete and ends with the data extraction being successful. Alternatively, when the decision 1612 determines that the data extraction has not been successful, then the download bot 1614 can be bypassed and the data extraction workflow process 1600 can end with the data extraction effort being unsuccessful.

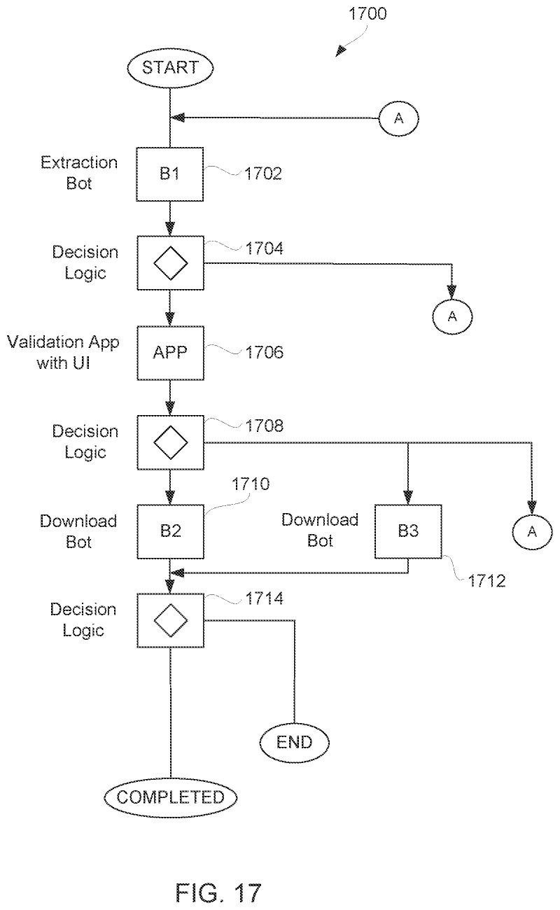

FIG. 17 illustrates a visual representation of an exemplary workflow process 1700 for data extraction. The visual representation of the exemplary workflow process 1700 shown in FIG. 17 depicts different types of tasks (e.g., human, bot or app) such that they are visually distinguished from one another. The visual representation also includes decision logic (e.g., condition logic) for process flow, such as branching.

The exemplary workflow process 1700 includes an arrangement of tasks, where some of which are interlinked with decisional logic. The exemplary workflow process 1700 can begin with an extraction bot (B1) 1702. The extraction bot 1702 can, for example, perform automated processing on an electronic document. Decision logic 1704 can then determine whether the data extraction by the extraction bot 1702 performed successfully and confidently. If the decision logic 1704 determines that the extraction bot 1702 should retry its data extraction by returning to the extraction bot 1702. On the other hand, if the decision logic 1704 determines that the data extraction was successful with a sufficient degree of confidence, then the exemplary workflow process 1700 can proceed to a validation application 1706. The validation application 1706 is a remote application program that also includes a validation user interface that can be presented to a user for human input. The validation user interface facilitates user validation of extracted data. The extracted data can be provided by the extraction bot 1702 and/or can be provided by the remote application program. The remote application program is, for example, an external task which can provide data extraction and/or data extraction validation capabilities. The remote application program provides data that is presented (e.g., displayed) via the validation user interface. The remote application program is, for example, the external application 1008 with associated user interface as noted in FIG. 10 or the external application 1506 with associated user interface as noted in FIG. 15.

Following the user interaction with the validation user interface, the exemplary workflow process 1700 can provide decision logic 1708. The decision logic 1708 can determine whether data validation by the remote validation application 1706 and the validation user interface has approved, disapproved or corrected the extracted data. If the decision logic 1708 determines that the extraction bot 1702 should retry its data extraction, then the exemplary workflow process 1700 can return to the extraction bot 1702 to re-perform data extraction. On the other hand, if the decision logic 1708 determines that the data extraction was successful, then the exemplary workflow process 1700 can proceed to download bot (B2) 1710 or download bot (B3) 1712. The download bot 1710 can download the extracted data that has been validated by the user input via the validation user interface associated with the remote validation application 1706. The download bot 1712 can download the extracted data that has been invalidated by the user input via the validation user interface associated with the remote validation application 1706. Thereafter, decision logic 1714 can determine whether the appropriate download has completed successfully. If the decision logic 1714 determines that the respective download has successfully completed with valid data, then the exemplary workflow process 1700 can end with the exemplary workflow process 1700 having been successful. If the decision logic 1714 determines that the download has successfully completed but with invalid data, then the exemplary workflow process 1700 can end with the exemplary workflow process 1700 having been unsuccessful.

In an automated workflow process, such the data extraction workflow process 1700 illustrated in FIG. 17, an example of a definition (i.e., description) that can be produced by the workflow process flatform, according to one exemplary embodiment, is as contained in U.S. Patent Provisional Application No. 63/285,081, filed Dec. 1, 2021, and entitled “ROBOTIC PROCESS AUTOMATION FOR MANAGING HUMAN, ROBOTIC AND EXTERNAL TASKS,” which is hereby incorporated herein by reference, see Appendix B thereof, which is included or incorporated herein into this document. Notable, in this exemplary embodiment, the automated workflow process for data extraction, such from an image of a document, is described in a computer-readable manner (e.g., JSON), such that the process can be implemented by one or more computing devices supporting the workflow process platform.

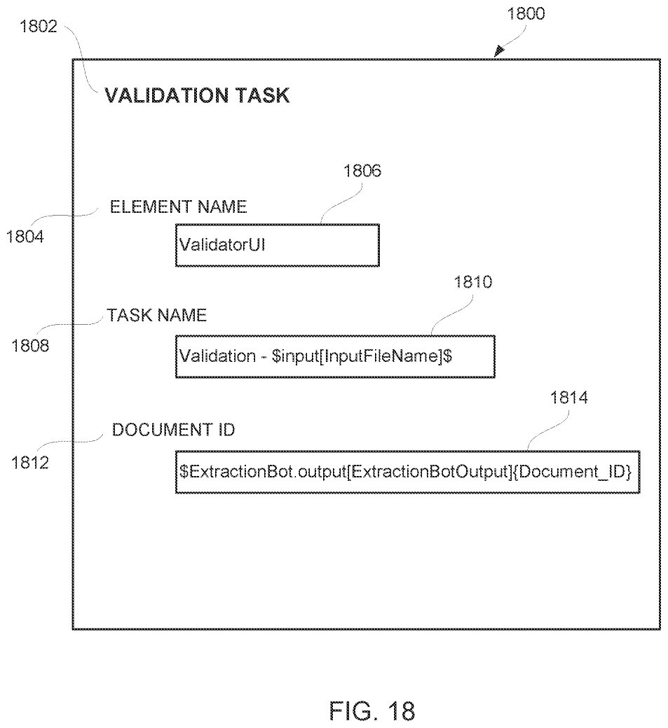

FIG. 18 illustrates a user interface 1800 for configuring a task to participate within a workflow process according to one embodiment. For example, the task can be configured for use in the exemplary workflow process 1700 shown in FIG. 17. The task can correspond to the validation application 1706 with its validation user interface. The task, in this embodiment, can be denoted as a validation task by its task name 1802. In this embodiment, the configuration of the task permits a user to: (i) designate an element name 1084 using a text box 1806 to configure a name for the task (e.g., ValidatorUl), (ii) designate a task name 1808 using a text box 1810 to identify an input file that is to be validated, and (iii) designate a document identifier (ID) using a text box 1814 to denote an output file for resulting validated data. More generally, the validation task being configured by the user interface 1800 can be affiliated with a validation application, validation bot and/or a validation user interface.

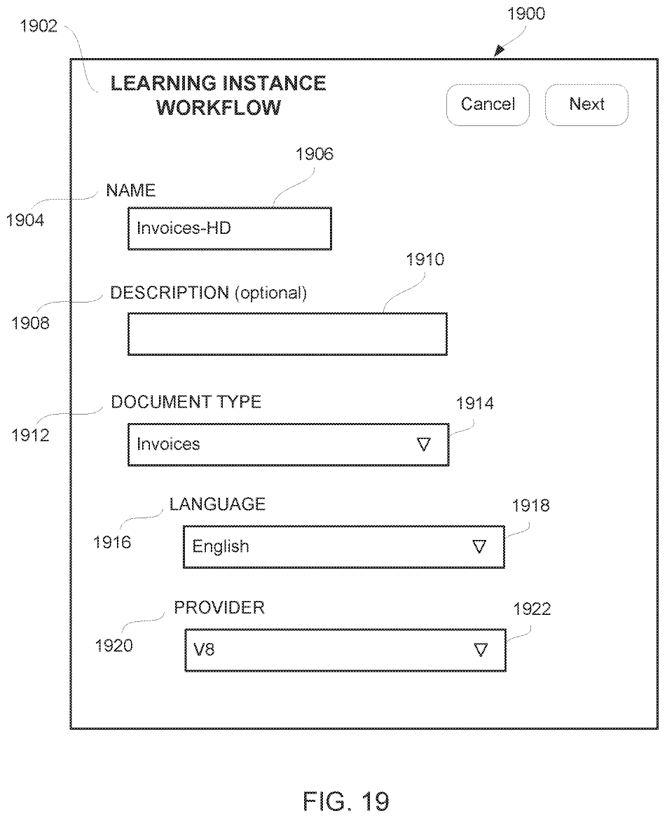

FIG. 19 illustrates a user interface 1900 for creating a learning instance workflow 1902 according to one embodiment. In this exemplary embodiment, the learning instance workflow 1902 pertains to automated processing of documents. More specifically, the learning instance workflow 1902 is providing automated data extraction from electronic documents. The learning instance workflow 1902 is a workflow process that can be carried out by a workflow process platform. In doing so, the user interface 1900 permits a user to: (i) designate a name 1904 for the learning instance workflow 1902 using text box 1906 to configure a name for the learning instance workflow 1902, (ii) designate a description 1908 of the learning instance workflow 1902 using text box 1910, and (iii) designate a document type 1912 using a text box 1914 (e.g., such as invoices, purchase orders, sales receipts, etc.). In this exemplary embodiment, the depicted in FIG. 19, the name for the learning instance workflow is “Invoices-HD.” Additionally, the user interface 1900 can also characterize the documents of the designated document type 1912 to (i) designate their language 1916 using a drop-down list 1918 and (ii) denote a provider 1920 of the documents using a drop-down list 1922. In this example, the provider is “V8” which denotes a robotic process automation product available from Automation Anywhere, Inc. from San Jose, Calif.

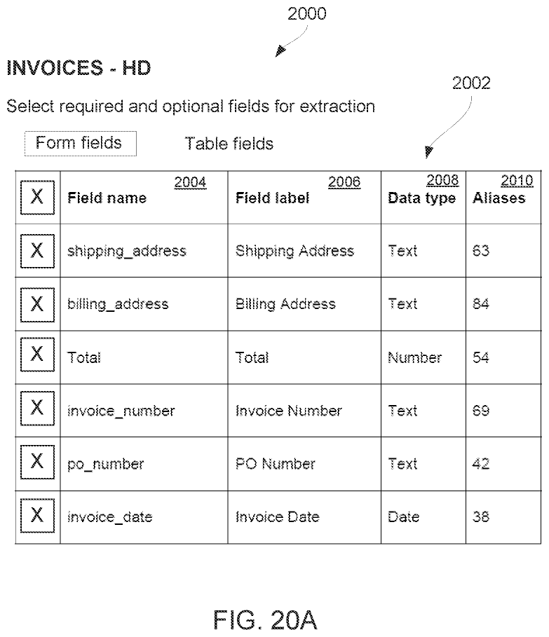

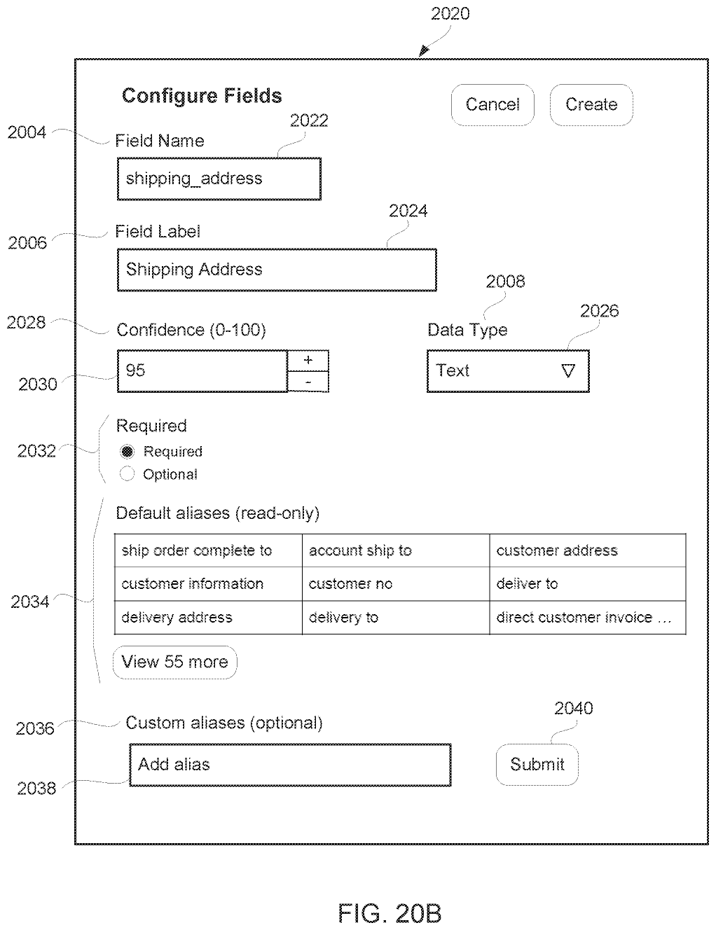

FIG. 20A illustrates a user interface 2000 for selection of fields for data extraction according to one embodiment. Using the user interface 2000, a user can configure which fields associated with documents to be processed for data extractions are to be considered. The user interface 2000 can, for example, by used to configure data extraction for the learning instance workflow named “Invoices-HD.” In the case of documents that are classified as having the document type “invoices” (as was configured in the user interface 1900), the user interface 2000 can support various fields. As shown in FIG. 20A, the supported fields can be presented in a table 2002 of form fields (or table fields). The table 2002 presents a field name 2004, a field label 2006, a data type 2008, and aliases 2010 for each of a plurality of supported fields. In this exemplary embodiment, the supported fields include shipping address, billing address, total, invoice number, PO number, and invoice data. Any of the supported fields can be selected or unselected for use in data extraction.

FIG. 20B illustrates a user interface 2020 for configuration of extraction processing for a selected field according to one embodiment. The user interface 2020 is a companion user interface to the user interface 2000 illustrated in FIG. 20A. In one implementation, the user interfaces 2000 and 2020 are displayed concurrently, such as side-by-side. On selection of one of the rows in the table 2002 of the user interface 2000 shown in FIG. 20A, the row and the associated fields can be selected. In this example, the first row in the table 2002 that pertains to the field “Shipping Address” is assumed to have been selected. As such, the user interface 2020 for that selected field is shown in FIG. 20B. Hence, as shown in the user interface 2020, the extraction settings for the “Shipping Address” field can be set. The extraction settings shown in the user interface 2020 can include the filed name 2004, the field label 2006 and data type 2008, which can be pre-populated since they are known. In one implementation, the field label 2006 is pre-populated in a text box 2022, the field label 2006 is pre-populated in a text box 2024, and the data type 2008 can be pre-populated in a drop-down list 2026. Optionally, the user can alter the field label 2006 and/or the data type 2008,

The user interface 2020 also include confidence setting section 2028 that includes a number entry box 2030 where the user can denote a confidence level to be applied for extraction of the associated field.

The user interface 2020 can also include a required/optional selection 2032 to denote whether the associated field is a field that is required to be extracted from a document, or whether the extraction for that field is optional. For example, as shown in the user interface 2020, the Shipping Address field is “required” and the confidence level must be at 95% confidence in the data extraction.

The user interface 2020 can also include an alias section 2034. Aliases are used to allow the data extraction to consider alternative names that may be used in documents to refer to the same field. The alias section 2034 can display a plurality of aliases for the shipping address field. These aliases are the aliases 2010 referred to in the table 2002 illustrated in FIG. 20A. Also, the number of aliases being displayed in the alias section 2034 may not include all of the associated aliases for the corresponding field. In such cases, the alias section 2034 can include a view more button.

The user interface 2020 also include a custom alias section 2036. The custom alias section 2036 permits a user to enter a new alias into a text box 2038 and then submit this new alias via submit button 2040 to the workflow process platform for use during data extraction with respect to the associated field.

Alternatively, the user interface 2020 can also be used to create a new field to be extracted from documents. On creation, the new field can be configured as noted above. After created, the new field would also appear in the list of fields in the table 2002 of the user interface 2000 shown in FIG. 20A.

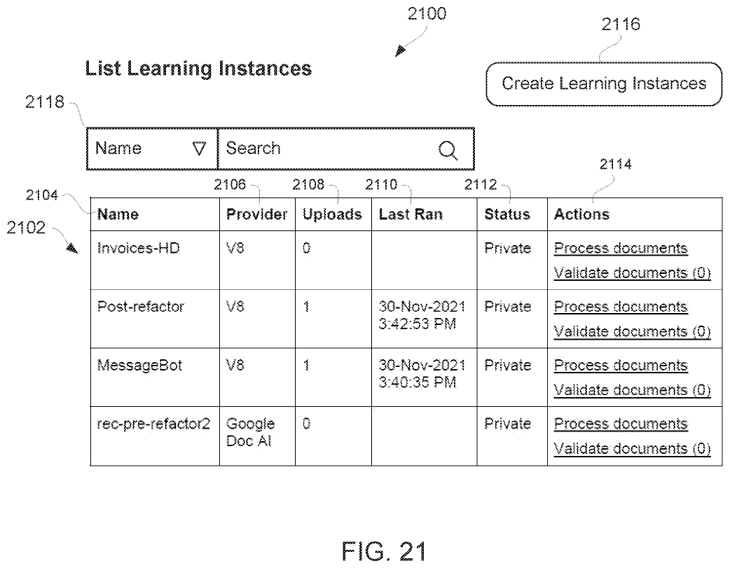

FIG. 21 illustrates a user interface 2100 for identification of previously created learning instances according to one embodiment. In this exemplary embodiment, the learning instances pertain to learning instance workflows that providing automated data extraction from electronic documents. The user interface 2100 includes a table 2102 that lists previously created and/or configured learning instances. The learning instances are workflow processes. Notably, the first listed leaning instance is named “Invoices-HD” and could have been created using user interactions such as noted above with respect to FIGS. 19, 20A and 20B. For each learning instance appearing in the table 2102, the table 2102 includes various fields of information, including workflow (e.g., learning instance) name 2104, provider 2106, uploads 2108, last ran 2110, status 2112, and actions 2114.

As illustrated, the action 2114 can include two command links, namely, a process documents link and a validate documents link. If the user selects the process documents link, then the corresponding workflow process (e.g., learning instance) is caused to be activated by the workflow process platform so that automated processing of documents can be performed. If the user selects the validate documents link, then the user is requesting to access a validation queue of user validations that the workflow process platform has awaiting to be validated by a user. As shown in the table 2102, the number of documents awaiting validation by a user can be denoted. For example, the “validation documents” link can be followed by a number of items in the queue, e.g., “(0)” representing no documents presently waiting validation.

The user interface 2100 can also include a “create learning instances” control 2118 (e.g., button) to cause the workflow process platform to assist a user in creating a learning instance (e.g., workflow process), such using the user interface noted above with respect to FIGS. 19, 20A and 20B. Furthermore, the user interface 2100 can include a search bar 2120 to permit a user to search the previously created learning instances for those that match user-designed search criteria.

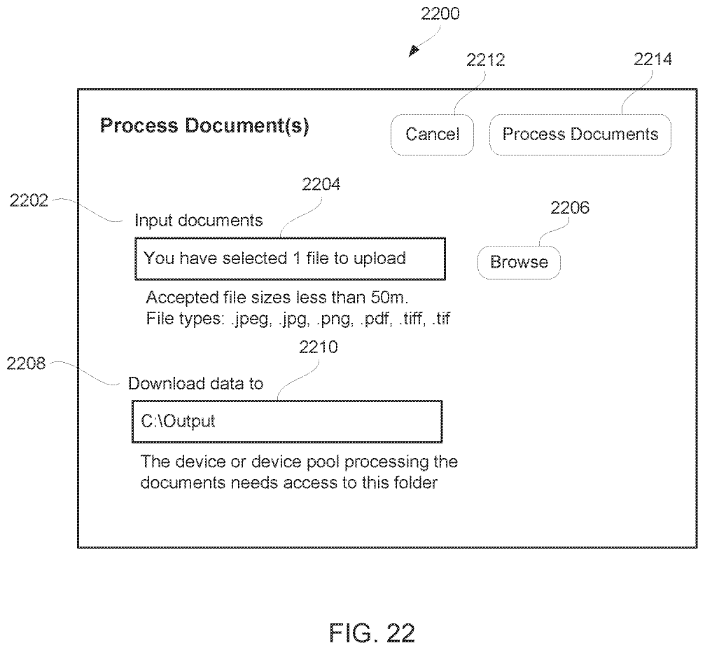

FIG. 22 illustrates a user interface 2200 for designating input documents and an output data destination for one or more documents to be processed by a workflow process, according to one embodiment. In one implementation, the user interface 2200 can be activated by selection of the process documents link as the action 2114 illustrated in FIG. 21. The user interface 2200 permits one or more input documents 2202 for processing to be identified using a text box 2204. The one or more input documents 2202 can be identified by use of a browse control 2206 to locate the desired one or more documents to be processed. The user interface 2200 also permits an output data file to be specified for storing output data resulting from processing of the one or more input documents 2202. The output data can be stored to an output data file 2208 that can be specified using a text box 2210. Additionally, the user interface 2200 can also include a cancel button 2212 to cancel the document processing request, and a process document button 2214 to proceed with the document processing request after having specified the input documents and output data destination.

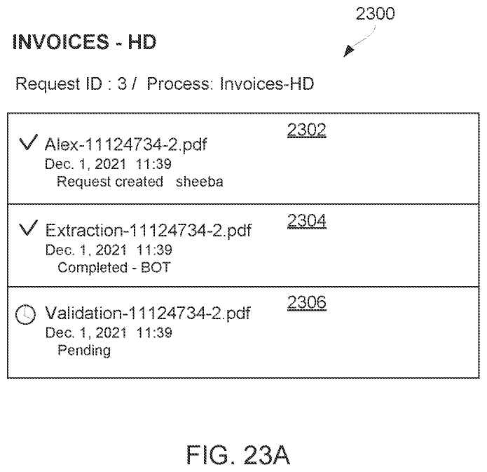

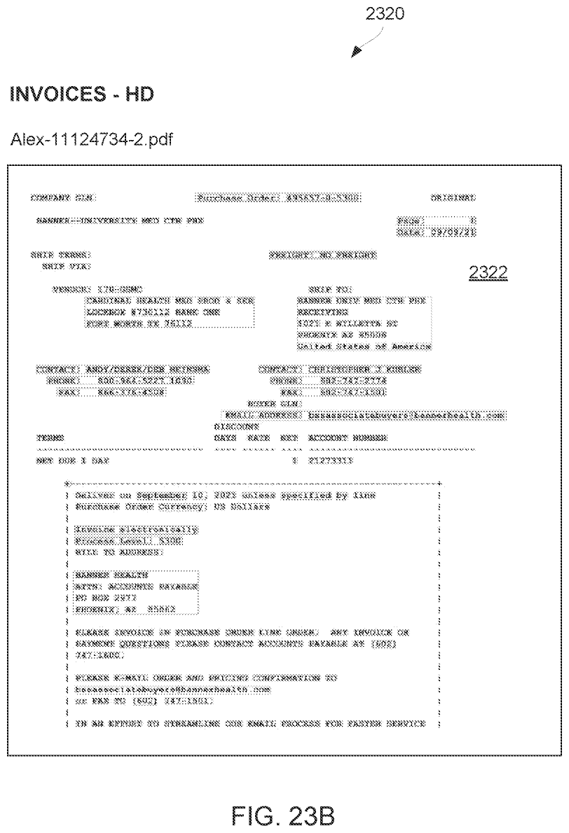

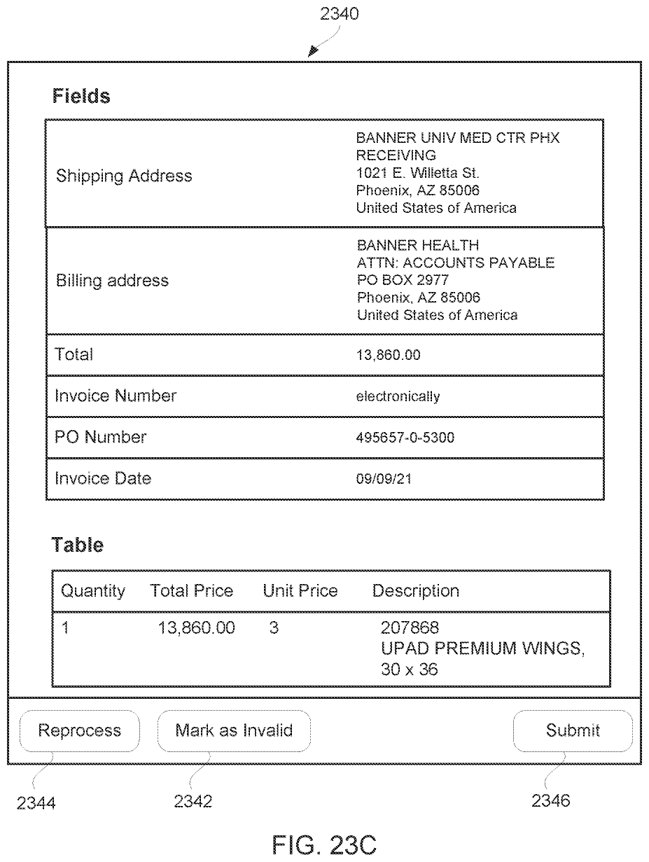

FIG. 23A illustrates a user interface 2300 providing completion status for steps of an exemplary workflow process. The user interface 2300 includes a first section 2302 for denoting status of a requested activation of the exemplary workflow process, a second section 2304 for denoting status of operation of a data extraction task of the exemplary workflow process, and a third section 2306 for denoting status of a user validation task of the exemplary workflow process. The first section 2302 denotes that the initiation of the exemplary workflow process was requested and initiated on Dec. 1, 2021, and that the exemplary workflow process is to perform data extraction with respect to document “Alex-11124734-2.pdf”. The second section 2304 denotes validation bot processing for the data extraction task by an extraction bot has completed its processing to extract data from the document “Alex-11124734-2.pdf”. The third section 2306 denotes that the validation task is currently pending and awaiting user interaction for validation of the data extracted by the extraction bot.

FIG. 23B illustrates a user interface 2320 presenting an annotated document 2322 according to one embodiment. The annotated document 2322 can indicate portions of an electronic document that have been processed for data extraction according to one embodiment. In this example, the annotated document 2322 being displayed is the document “Alex-11124734-2.pdf” as annotated by the data extraction processing. In particular, the text regions of interest in the document are recognized, such as by field recognition, and visually denoted by a bounding box, and visually presented as the annotated document 2302. The data within the bounding boxes is recognized and thus extracted from the electronic document.

FIG. 23C illustrated a validation user interface 2340 according to one embodiment. The validation user interface 2340 can present extracted data from the data extraction processing for user validation. The extracted data is data that has been extracted from an electronic document. The electronic document can be processed by an extraction bot and yield extracted data, such as illustrated in FIG. 23B. In the embodiment shown in FIG. 23C, the user interface 2340 can present the extracted data pertaining to the fields within the electronic document, which can, for example, include field such as: shipping address, billing address, total, invoice number, PO number, and invoice date. For each of the fields, the extracted data (if any) corresponding thereto, as determined by the extraction bot through automated processing, can be presented by the validation user interface 2340. For example, as shown in FIG. 23C, for the field “Invoice Date”, the extracted data presented is “09/09/21”. The user interface 2340 can also present extracted data from one or more tables within the electronic document. In the embodiment shown in FIG. 23C, the user interface 2340 can present the extracted data from a table, which can, for example, include quantity, total price, unit price and description. The user is then able to validated the extracted data for the presented fields and/or table(s). In doing so, the user can select an appropriate user control to invalidate some or all of the extracted data (“Mark as invalid” button 2342), cause reprocess of document to redo the data extraction processing (“Reprocess” button 2344), or accept some or all of the extracted data (“Submit” button 2346)

The user interfaces 2300, 2320 and 2340 shown in FIGS. 23A, 23B and 23C, respectively can be presented to a user as portions of a single user interface or as separate user interfaces. When presented as a single user interface, the user interfaces 2300, 2320 and 2340 can be displayed concurrently, such as side-by-side.

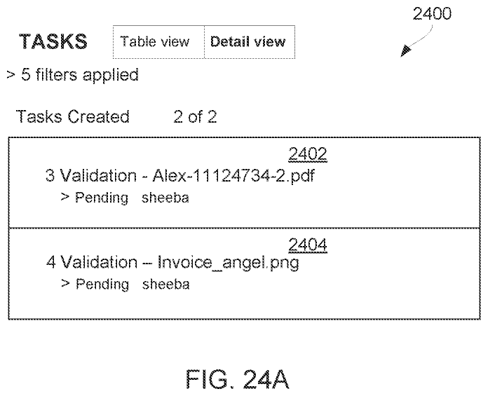

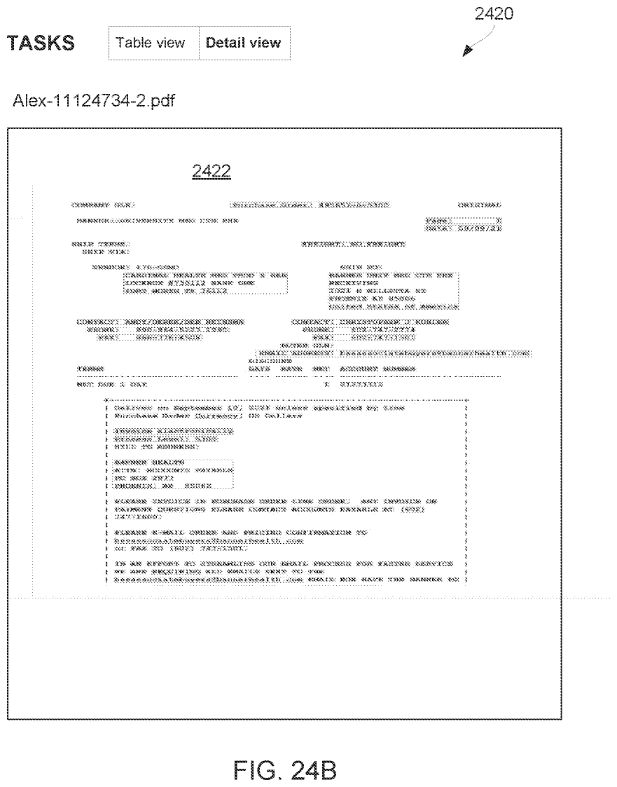

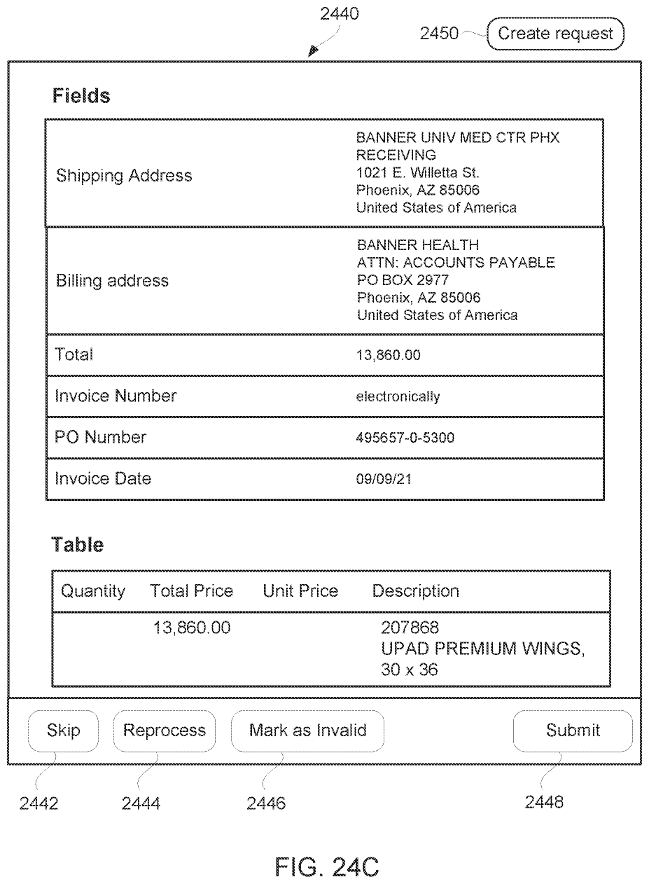

FIG. 24A illustrates a user interface 2400 illustrating a validation queue according to one embodiment. The validation queue indicates one or more data extractions from images of electronic documents that are to be user validated. In other words, the validation queue is listing pending validation tasks. The validation effort is part of the exemplary workflow process that is operating to automatically extract data from electronic document, and provide for user validation thereof. The user interface 2400 includes a first validation item 2402, and a second validation item 2404. The first validation item 2402 is a pending task for a user to validate the data extraction extract data from the document image “Alex-11124734-2.pdf”. The second validation item 2404 is a pending task for a user to validate the data extraction data from the document image “Invoice-angel.png”. The user interface 2400 also denote that the first validation item 2402 and the second validation item 2404 are assigned to the user “sheeba” for validation.

FIG. 24B illustrates a user interface 2420 presenting an annotated document 2422 according to one embodiment. The annotated document 2422 is the document corresponding to the first validation item 2402 illustrated in FIG. 24A. The annotated document 2422 can indicate portions of an electronic document that have been processed for data extraction according to one embodiment. In this example, the annotated document 2422 being displayed is the document “Alex-11124734-2.pdf” as annotated by the data extraction processing. In particular, the text regions of interest in the document are recognized, such as by field recognition, and visually denoted by a bounding box, and visually presented as the annotated document 2402. The data within the bounding boxes is recognized and thus extracted from the electronic document. The annotated document 2422 can be presented in the user interface 2420 so that the user that undertakes the user validation is able to view the native document and where data has been automatically extracted therefrom.

FIG. 24C illustrated a validation user interface 2360 according to one embodiment. The validation user interface 2360 can present extracted data from the data extraction processing for user validation. The extracted data is data that has been extracted from an electronic document. The electronic document can be processed by an extraction hot and yield extracted data, such as illustrated in FIG. 24B. In the embodiment shown in FIG. 24C, the user interface 2440 can present the extracted data pertaining to the fields within the electronic document, which can, for example, include fields such as: shipping address, billing address, total, invoice number, PO number, and invoice date. For each of the fields, the extracted data (if any) corresponding thereto, as determined by the extraction bot through automated processing, can be presented by the validation user interface 2440. For example, as shown in FIG. 24C, for the field “Invoice Date”, the extracted data presented is “09/09/21”. The user interface 2440 can also present extracted data from one or more tables within the electronic document. In the embodiment shown in FIG. 240, the user interface 2440 can present the extracted data from a table, which can, for example, include quantity, total price, unit price and description. The user is then able to validate the extracted data for the presented fields and/or table(s). In doing so, for the particular extracted data item for a particular field, the user can select an appropriate user control. In this embodiment, the available user controls include controls to (i) skip a particular validation (“Skip” button 2442), (ii) cause reprocess of that data extraction item (or perhaps the entire document) to redo the data extraction processing (“Reprocess” button 2444), (iii) invalidate at least that data extraction item (“Mark as invalid” button 2446). After considering the various extracted data items to be validated, another user control can be selected to accept some or all of the extracted data (“Submit” button 2448). Further still, the user interface 2440 can also include a user control 2450 (labeled “Create request”) that enables a user to create a request for data extraction.

The user interfaces 2400, 2420 and 2440 shown in FIGS. 24A, 24B and 24C, respectively can be presented to a user as portions of a single user interface or as separate user interfaces. When presented as a single user interface, the user interfaces 2300, 2320 and 2340 can be displayed concurrently, such as side-by-side, which is this embodiment can be referred to as a detailed view.

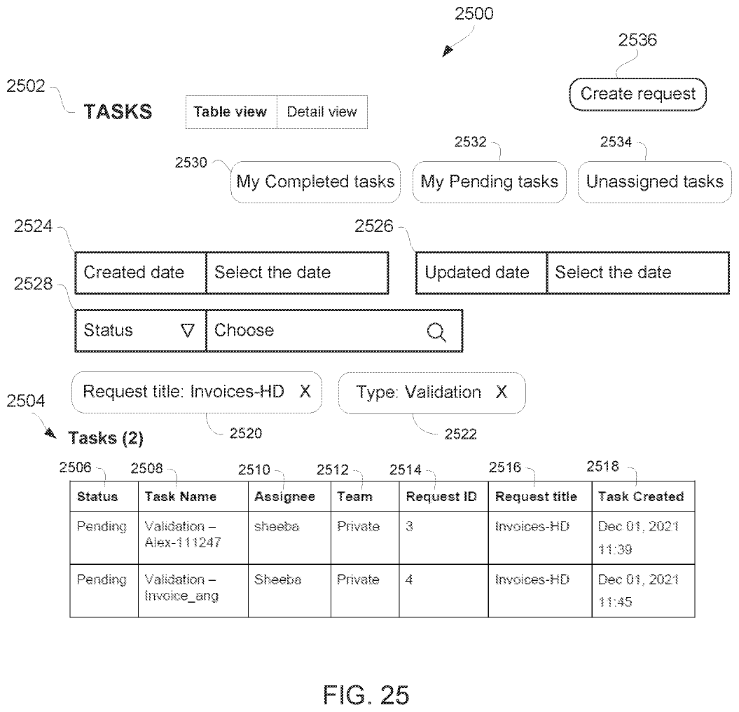

FIG. 25 illustrates a user interface 2500 illustrating a validation queue according to one embodiment. The user interface 2500 depicts tasks 2502 of the validation queue in a table view, as presented in a task table 2504. The validation queue shown in FIG. 25, like the validation queue shown in FIG. 24A, indicates one or more data extractions from images of electronic documents that are to be user validated. In other words, the validation queue lists pending validation tasks. The validation effort is part of the exemplary workflow process that is operating to automatically extract data from electronic document, and provide for user validation thereof. In the embodiment shown in FIG. 25, the task table 2504 presents a table of pending user validations to be carried out. The task table 2504 can, for example, include information concerning status 2506, task name 2508, assignee 2510, team 2512, request ID 2514, request title 2516, and task created 2518.

The user interface 2500 can also include one or more filter selections to filter those of the task of the exemplary workflow process that are to be displayed in the task table 2504. As illustrated in FIG. 25, two filters are applied, first filter 2520 is for task(s) that have a request title that matches “Invoices-HD”, and a second filter 2522 is for tasks(s) that have a type of “validation”. Hence, as configured, the task table 2504 is displaying two matching tasks, which are pending user validation concerning the exemplary workflow process pertaining to Invoices-HD, The first matching task is a pending task for a user to validate the data extraction extract data from the document image “Alex-11124734-2.pdf”. The second masking task is a pending task for a user to validate the data extraction data from the document image “Invoice-angel.png”. The user interface 2500 also denotes that the first matching task and the second matching task are assigned to the user “sheeba” for validation.

The user interface 2500 can also include filtering controls that allow a user to select one or more filtering criteria to set filters. The first filter 2520 and the second filter 2520 can have been previously configured by use of one or more of the filtering controls. As depicted in FIG. 25, the filtering controls can include a created date filter control 2524, an updated date filter control 2526, and a status filter control 2528.

The user interface 2500 can also include one or more specific user controls to cause certain subsets of tasks to be presented in the task table 2504, As shown in FIG. 25, the one or more specific user controls can include (i) a first specific user control 2530 (labeled “My Completed tasks”) to cause those task that have been completed by the user to be presented in the task table 2504; (ii) a second specific user control 2532 (labeled “My Pending tasks”) to cause those task that are pending and assigned to the user to be presented in the task table 2504; and (iii) a third specific user control 2534 (labeled “Unassigned tasks”) to cause those task that are currently unassigned to be presented in the task table 2504. Further still, the user interface 2500 can also include a user control 2536 (labeled “Create request”) that enables a user to create a request for data extraction.

The various aspects disclosed herein can be utilized with or by robotic process automation systems. Exemplary robotic process automation systems and operations thereof are detailed below.

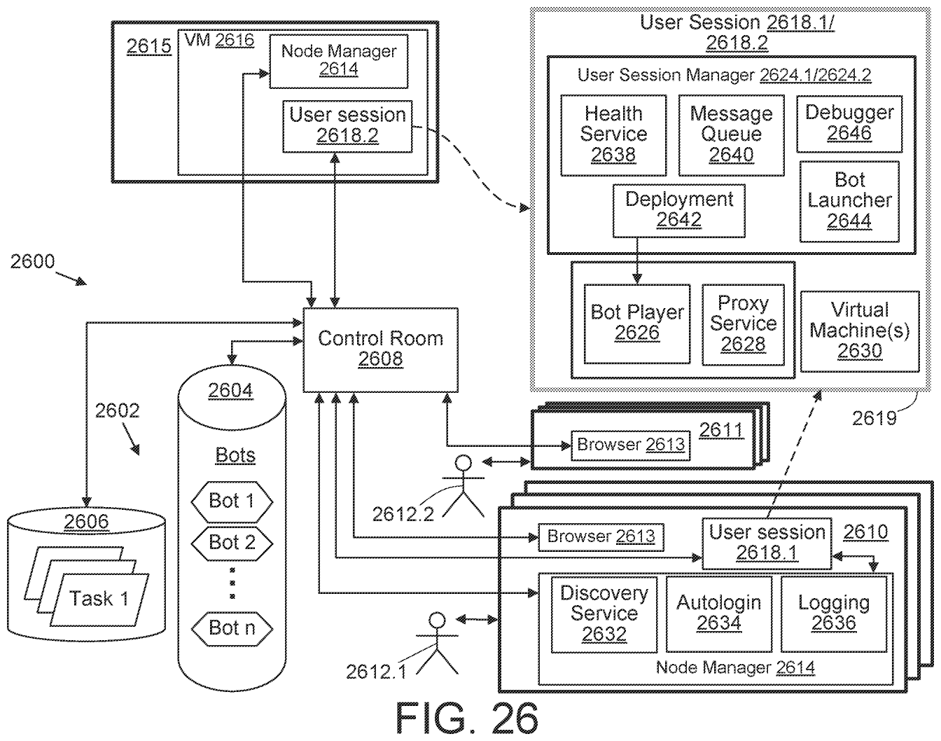

FIG. 26 is a block diagram of a robotic process automation (RPA) system 2600 according to one embodiment. The RPA system 2600 includes data storage 2602. The data storage 2602 can store a plurality of software robots 2604, also referred to as bots (e.g., Bot 1, Bot 2, . . . , Bot n, where n is an integer). The software robots 2604 can be operable to interact at a user level with one or more user level application programs (not shown). As used herein, the term “bot” is generally synonymous with the term software robot. In certain contexts, as will be apparent to those skilled in the art in view of the present disclosure, the term “bot runner” refers to a device (virtual or physical), having the necessary software capability (such as bot player 2626), on which a bot will execute or is executing. The data storage 2602 can also stores a plurality of work items 2606. Each work item 2606 can pertain to processing executed by one or more of the software robots 2604.

The RPA system 2600 can also include a control room 2608. The control room 2608 is operatively coupled to the data storage 2602 and is configured to execute instructions that, when executed, cause the RPA system 2600 to respond to a request from a client device 2610 that is issued by a user 2612.1. The control room 2608 can act as a server to provide to the client device 2610 the capability to perform an automation task to process a work item from the plurality of work items 2606. The RPA system 2600 is able to support multiple client devices 2610 concurrently, each of which will have one or more corresponding user session(s) 2618, which provides a context. The context can, for example, include security, permissions, audit trails, etc. to define the permissions and roles for bots operating under the user session 2618. For example, a bot executing under a user session cannot access any files or use any applications that the user, under whose credentials the bot is operating, does not have permission to do so. This prevents any inadvertent or malicious acts from a bot under which bot 2604 executes.

The control room 2608 can provide, to the client device 2610, software code to implement a node manager 2614. The node manager 2614 executes on the client device 2610 and provides a user 2612 a visual interface via browser 2613 to view progress of and to control execution of automation tasks. It should be noted that the node manager 2614 can be provided to the client device 2610 on demand, when required by the client device 2610, to execute a desired automation task. In one embodiment, the node manager 2614 may remain on the client device 2610 after completion of the requested automation task to avoid the need to download it again. In another embodiment, the node manager 2614 may be deleted from the client device 2610 after completion of the requested automation task. The node manager 2614 can also maintain a connection to the control room 2608 to inform the control room 2608 that device 2610 is available for service by the control room 2608, irrespective of whether a live user session 2618 exists. When executing a bot 2604, the node manager 2614 can impersonate the user 2612 by employing credentials associated with the user 2612.

The control room 2608 initiates, on the client device 2610, a user session 2618 (seen as a specific instantiation 2618.1) to perform the automation task. The control room 2608 retrieves the set of task processing instructions 2604 that correspond to the work item 2606. The task processing instructions 2604 that correspond to the work item 2606 can execute under control of the user session 2618.1, on the client device 2610. The node manager 2614 can provide update data indicative of status of processing of the work item to the control room 2608. The control room 2608 can terminate the user session 2618.1 upon completion of processing of the work item 2606. The user session 2618.1 is shown in further detail at 2619, where an instance 2624.1 of user session manager 2624 is seen along with a bot player 2626, proxy service 2628, and one or more virtual machine(s) 2630, such as a virtual machine that runs Java® or Python®. The user session manager 2624 provides a generic user session context within which a bot 2604 executes.

The bots 2604 execute on a bot player, via a computing device, to perform the functions encoded by the bot. Some or all of the bots 2604 may, in certain embodiments, be located remotely from the control room 2608. Moreover, the devices 2610 and 2611, which may be conventional computing devices, such as for example, personal computers, server computers, laptops, tablets and other portable computing devices, may also be located remotely from the control room 2608. The devices 2610 and 2611 may also take the form of virtual computing devices. The bots 2604 and the work items 2606 are shown in separate containers for purposes of illustration but they may be stored in separate or the same device(s), or across multiple devices. The control room 2608 can perform user management functions, source control of the bots 2604, along with providing a dashboard that provides analytics and results of the bots 2604, performs license management of software required by the bots 2604 and manages overall execution and management of scripts, clients, roles, credentials, security, etc. The major functions performed by the control room 2608 can include: (i) a dashboard that provides a summary of registered/active users, tasks status, repository details, number of clients connected, number of scripts passed or failed recently, tasks that are scheduled to be executed and those that are in progress, and any other desired information; (ii) user/role management—permits creation of different roles, such as bot creator, bot runner, admin, and custom roles, and activation, deactivation and modification of roles; (iii) repository management—to manage all scripts, tasks, workflows and reports etc.; (iv) operations management—permits checking status of tasks in progress and history of all tasks, and permits the administrator to stop/start execution of bots currently executing; (v) audit trail—logs creation of all actions performed in the control room; (vi) task scheduler—permits scheduling tasks which need to be executed on different clients at any particular time; (vii) credential management—permits password management; and (viii) security: management—permits rights management for all user roles. The control room 2608 is shown generally for simplicity of explanation. Multiple instances of the control room 2608 may be employed where large numbers of bots are deployed to provide for scalability of the RPA system 2600.

In the event that a device, such as device 2611 (e.g., operated by user 2612.2) does not satisfy the minimum processing capability to run a node manager 2614, the control room 2608 can make use of another device, such as device 2615, that has the requisite capability. In such case, a node manager 2614 within a Virtual Machine (VM), seen as VM 2616, can be resident on the device 2615. The node manager 2614 operating on the device 2615 can communicate with browser 2613 on device 2611. This approach permits RPA system 2600 to operate with devices that may have lower processing capability, such as older laptops, desktops, and portable/mobile devices such as tablets and mobile phones. In certain embodiments the browser 2613 may take the form of a mobile application stored on the device 2611. The control room 2608 can establish a user session 2618.2 for the user 2612.2 while interacting with the control room 2608 and the corresponding user session 2618.2 operates as described above for user session 2618.1 with user session manager 2624 operating on device 2610 as discussed above.

In certain embodiments, the user session manager 2624 can provide five functions. First is a health service 2638 that maintains and provides a detailed logging of bot execution including monitoring memory and CPU usage by the bot and other parameters such as number of file handles employed. The bots 2604 can employ the health service 2638 as a resource to pass logging information to the control room 2608. Execution of the bot is separately monitored by the user session manager 2624 to track memory, CPU, and other system information. The second function provided by the user session manager 2624 is a message queue 2640 for exchange of data between bots executed within the same user session 2618. The third function is a deployment service (also referred to as a deployment module) 2642 that connects to the control room 2608 to request execution of a requested bot 2604. The deployment service 2642 can also ensure that the environment is ready for bot execution, such as by making available dependent libraries. The fourth function is a bot launcher 2644 which can read metadata associated with a requested bot 2604 and launch an appropriate container and begin execution of the requested bot. The fifth function is a debugger service 2646 that can be used to debug bot code.

The bot player 2626 can execute, or play back, a sequence of instructions encoded in a bot. The sequence of instructions can, for example, be captured by way of a recorder when a human performs those actions, or alternatively the instructions are explicitly coded into the bot. These instructions enable the bot player 2626, to perform the same actions as a human would do in their absence. In one implementation, the instructions can compose of a command (or action) followed by set of parameters. For example, “Open Browser” is a command and a URL would be the parameter for it to launch a web resource. Proxy service 2628 can enable integration of external software or applications with the bot to provide specialized services. For example, an externally hosted artificial intelligence system can enable the bot to understand the meaning of a “sentence.”

The user 2612.1 can interact with node manager 2614 via a conventional browser 2613 which employs the node manager 2614 to communicate with the control room 2608. When the user 2612.1 logs in from the client device 2610 to the control room 2608 for the first time, the user 2612.1 can be prompted to download and install the node manager 2614 on the device 2610, if one is not already present. The node manager 2614 can establish a web socket connection to the user session manager 2624, deployed by the control room 2608 that lets the user 2612.1 subsequently create, edit, and deploy the bots 2604.

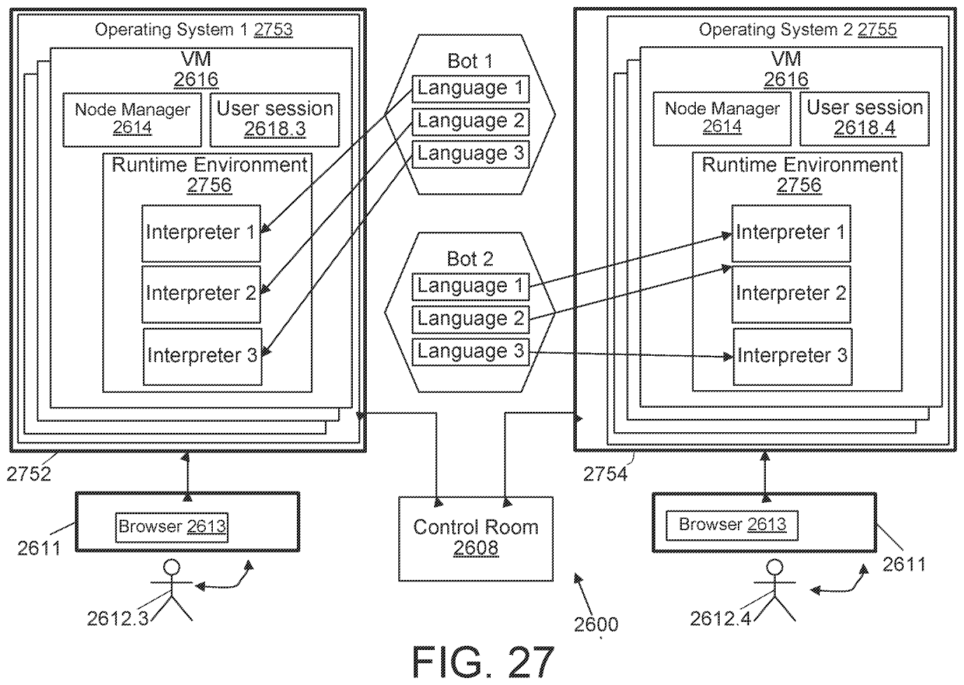

FIG. 27 is a block diagram of a generalized runtime environment for bots 2604 in accordance with another embodiment of the RPA system 2600 illustrated in FIG. 26. This flexible runtime environment advantageously permits extensibility of the platform to enable use of various languages in encoding bots. In the embodiment of FIG. 27, RPA system 2600 generally operates in the manner described in connection with FIG. 26, except that in the embodiment of FIG. 27, some or all of the user sessions 2618 execute within a virtual machine 2616. This permits the bots 2604 to operate on an RPA system 2600 that runs on an operating system different from an operating system on which a bot 2604 may have been developed. For example, if a bot 2604 is developed on the Windows® operating system, the platform agnostic embodiment shown in FIG. 27 permits the bot 2604 to be executed on a device 2752 or 2754 executing an operating system 2753 or 2755 different than Windows®, such as, for example, Linux. In one embodiment, the VM 2616 takes the form of a Java Virtual Machine (JVM) as provided by Oracle Corporation. As will be understood by those skilled in the art in view of the present disclosure, a JVM enables a computer to run Java® programs as well as programs written in other languages that are also compiled to Java® bytecode.

In the embodiment shown in FIG. 27, multiple devices 2752 can execute operating system 1, 2753, which may, for example, be a Windows® operating system. Multiple devices 2754 can execute operating system 2, 2755, which may, for example, be a Linux® operating system. For simplicity of explanation, two different operating systems are shown, by way of example and additional operating systems such as the macOS®, or other operating systems may also be employed on devices 2752, 2754 or other devices. Each device 2752, 2754 has installed therein one or more VM's 2616, each of which can execute its own operating system (not shown), which may be the same or different than the host operating system 2753/2755. Each VM 2616 has installed, either in advance, or on demand from control room 2608, a node manager 2614. The embodiment illustrated in FIG. 27 differs from the embodiment shown in FIG. 26 in that the devices 2752 and 2754 have installed thereon one or more VMs 2616 as described above, with each VM 2616 having an operating system installed that may or may not be compatible with an operating system required by an automation task. Moreover, each VM has installed thereon a runtime environment 2756, each of which has installed thereon one or more interpreters (shown as interpreter 1, interpreter 2, interpreter 3). Three interpreters are shown by way of example but any run time environment 2756 may, at any given time, have installed thereupon less than or more than three different interpreters. Each interpreter 2756 is specifically encoded to interpret instructions encoded in a particular programming language. For example, interpreter 1 may be encoded to interpret software programs encoded in the Java® programming language, seen in FIG. 27 as language 1 in Bot 1 and Bot 2. Interpreter 2 may be encoded to interpret software programs encoded in the Python® programming language, seen in FIG. 27 as language 2 in Bot 1 and Bot 2, and interpreter 3 may be encoded to interpret software programs encoded in the R programming language, seen in FIG. 27 as language 3 in Bot 1 and Bot 2.

Turning to the bots Bot 1 and Bot 2, each bot may contain instructions encoded in one or more programming languages. In the example shown in FIG. 27, each bot can contain instructions in three different programming languages, for example, Java®, Python® and R. This is for purposes of explanation and the embodiment of FIG. 27 may be able to create and execute bots encoded in more or less than three programming languages. The VMs 2616 and the runtime environments 2756 permit execution of bots encoded in multiple languages, thereby permitting greater flexibility in encoding bots. Moreover, the VMs 2616 permit greater flexibility in bot execution. For example, a bot that is encoded with commands that are specific to an operating system, for example, open a file, or that requires an application that runs on a particular operating system, for example, Excel® on Windows®, can be deployed with much greater flexibility. In such a situation, the control room 2608 will select a device with a VM 2616 that has the Windows® operating system and the Excel® application installed thereon. Licensing fees can also be reduced by serially using a particular device with the required licensed operating system and application(s), instead of having multiple devices with such an operating system and applications, which may be unused for large periods of time.

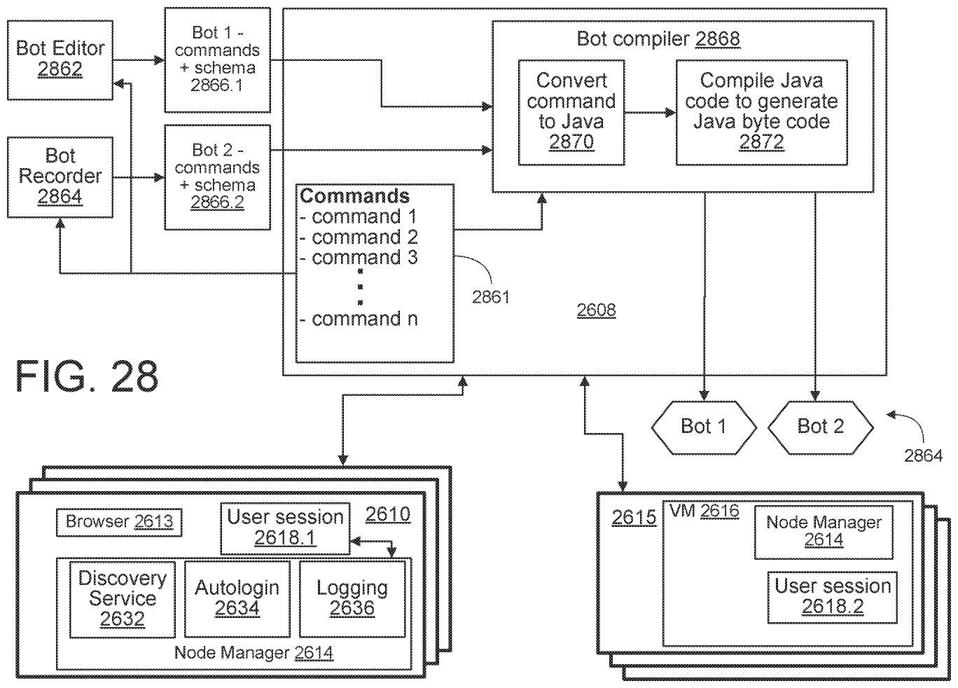

FIG. 28 illustrates a block diagram of yet another embodiment of the RPA system 2600 of FIG. 26 configured to provide platform independent sets of task processing instructions for bots 2604. Two bots 2604, bot 1 and bot 2 are shown in FIG. 28. Each of bots 1 and 2 are formed from one or more commands 2801, each of which specifies a user level operation with a specified application program, or a user level operation provided by an operating system. Sets of commands 2806.1 and 2806.2 may be generated by bot editor 2802 and bot recorder 2804, respectively, to define sequences of application-level operations that are normally performed by a human user. The bot editor 2802 may be configured to combine sequences of commands 2801 via an editor. The bot recorder 2804 may be configured to record application-level operations performed by a user and to convert the operations performed by the user to commands 2801. The sets of commands 2806.1 and 2806.2 generated by the editor 2802 and the recorder 2804 can include command(s) and schema for the command(s), where the schema defines the format of the command(s). The format of a command can include the input(s) expected by the command and their format. For example, a command to open a URL might include the URL, a user login, and a password to login to an application resident at the designated URL.

The control room 2608 operates to compile, via compiler 2808, the sets of commands generated by the editor 2802 or the recorder 2804 into platform independent executables, each of which is also referred to herein as a bot JAR (Java ARchive) that perform application-level operations captured by the bot editor 2802 and the bot recorder 2804. In the embodiment illustrated in FIG. 28, the set of commands 2806, representing a bot file, can be captured in a JSON (JavaScript Object Notation) format which is a lightweight data-interchange text-based format. JSON is based on a subset of the JavaScript Programming Language Standard ECMA-262 3d Edition—December 1999. JSON is built on two structures: (i) a collection of name/value pairs; in various languages, that can be realized as an object, record, struct, dictionary, hash table, keyed list, or associative array, (ii) an ordered list of values which, in most languages, is realized as an array, vector, list, or sequence. Bots 1 and 2 may be executed on devices 2610 and/or 2615 to perform the encoded application-level operations that are normally performed by a human user.

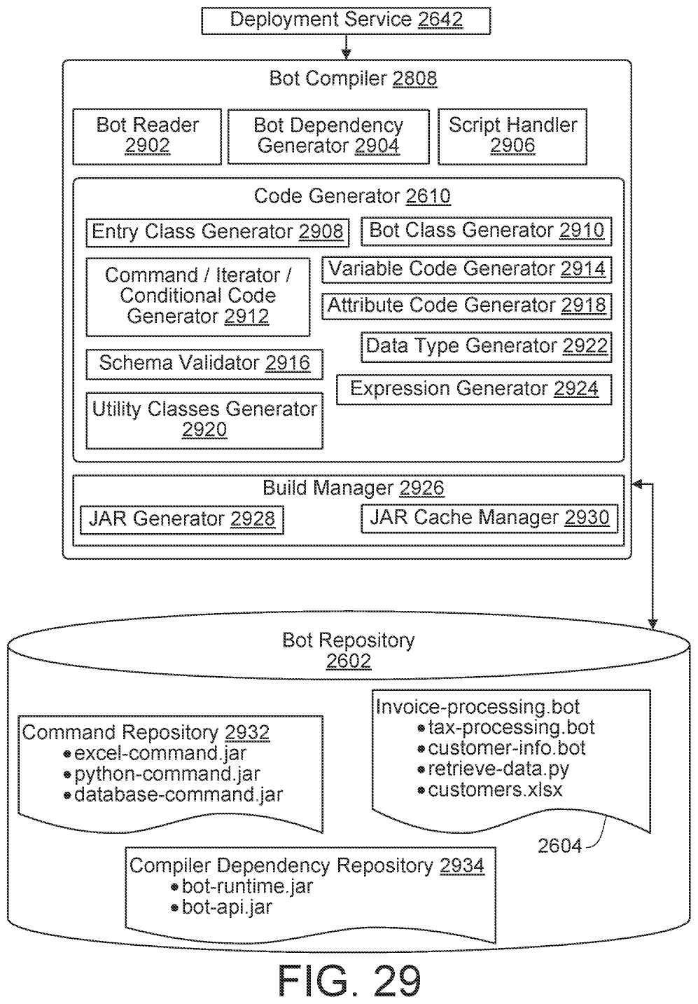

FIG. 29 is a block diagram illustrating details of one embodiment of the bot compiler 2808 illustrated in FIG. 28. The bot compiler 2808 accesses one or more of the bots 2604 from the data storage 2602, which can serve as bot repository, along with commands 2801 that are contained in a command repository 2932. The bot compiler 2608 can also access compiler dependency repository 2934. The bot compiler 2608 can operate to convert each command 2801 via code generator module 2810 to an operating system independent format, such as a Java command. The bot compiler 2608 then compiles each operating system independent format command into byte code, such as Java byte code, to create a bot JAR. The convert command to Java module 2810 is shown in further detail in FIG. 29 by JAR generator 2928 of a build manager 2926. The compiling to generate Java byte code module 2812 can be provided by the JAR generator 2928. In one embodiment, a conventional Java compiler, such as javac from Oracle Corporation, may be employed to generate the bot JAR (artifacts). As will be appreciated by those skilled in the art, an artifact in a Java environment includes compiled code along with other dependencies and resources required by the compiled code. Such dependencies can include libraries specified in the code and other artifacts. Resources can include web pages, images, descriptor files, other files, directories and archives.

As noted in connection with FIG. 28, deployment service 2642 can be responsible to trigger the process of bot compilation and then once a bot has compiled successfully, to execute the resulting bot JAR on selected devices 2610 and/or 2615. The bot compiler 2808 can comprises a number of functional modules that, when combined, generate a bot 2604 in a JAR format. A bot reader 2902 loads a bot file into memory with class representation. The bot reader 2902 takes as input a bot file and generates an in-memory bot structure. A bot dependency generator 2904 identifies and creates a dependency graph for a given bot. It includes any child bot, resource file like script, and document or image used while creating a bot. The bot dependency generator 2904 takes, as input, the output of the bot reader 2902 and provides, as output, a list of direct and transitive bot dependencies. A script handler 2906 handles script execution by injecting a contract into a user script file. The script handler 2906 registers an external script in manifest and bundles the script as a resource in an output JAR. The script handler 2906 takes, as input, the output of the bot reader 2902 and provides, as output, a list of function pointers to execute different types of identified scripts like Python, Java, or VB scripts.

An entry class generator 2908 can create a Java class with an entry method, to permit bot execution to be started from that point. For example, the entry class generator 2908 takes, as an input, a parent bot name, such “Invoice-processing.bot” and generates a Java class having a contract method with a predefined signature. A bot class generator 2910 can generate a bot class and orders command code in sequence of execution. The bot class generator 2910 can take, as input, an in-memory bot structure and generates, as output, a Java class in a predefined structure. A Command/Iterator/Conditional Code Generator 2912 wires up a command class with singleton object creation, manages nested command linking, iterator (loop) generation, and conditional (If/Else If/Else) construct generation. The Command/Iterator/Conditional Code Generator 2912 can take, as input, an in-memory bot structure in JSON format and generates Java code within the bot class. A variable code generator 2914 generates code for user defined variables in the bot, maps bot level data types to Java language compatible types, and assigns initial values provided by user. The variable code generator 2914 takes, as input, an in-memory bot structure and generates Java code within the bot class. A schema validator 2916 can validate user inputs based on command schema and includes syntax and semantic checks on user provided values. The schema validator 2916 can take, as input, an in-memory bot structure and generates validation errors that it detects. The attribute code generator 2918 can generate attribute code, handles the nested nature of attributes, and transforms bot value types to Java language compatible types. The attribute code generator 2918 takes, as input, an in-memory bot structure and generates Java code within the bot class. A utility classes generator 2920 can generate utility classes which are used by an entry class or bot class methods. The utility classes generator 2920 can generate, as output, Java classes. A data type generator 2922 can generate value types useful at runtime. The data type generator 2922 can generate, as output, Java classes. An expression generator 2924 can evaluate user inputs and generates compatible Java code, identifies complex variable mixed user inputs, inject variable values, and transform mathematical expressions. The expression generator 2924 can take, as input, user defined values and generates, as output, Java compatible expressions.

The JAR generator 2928 can compile Java source files, produces byte code and packs everything in a single JAR, including other child bots and file dependencies. The JAR generator 2928 can take, as input, generated Java files, resource files used during the bot creation, bot compiler dependencies, and command packages, and then can generate a JAR artifact as an output. The JAR cache manager 2930 can put a bot JAR in cache repository so that recompilation can be avoided if the bot has not been modified since the last cache entry. The JAR cache manager 2930 can take, as input, a bot JAR.

In one or more embodiments described herein, command action logic can be implemented by commands 2801 available at the control room 2608. This permits the execution environment on a device 2610 and/or 2615, such as exists in a user session 2618, to be agnostic to changes in the command action logic implemented by a bot 2604. In other words, the manner in which a command implemented by a bot 2604 operates need not be visible to the execution environment in which a bot 2604 operates. The execution environment is able to be independent of the command action logic of any commands implemented by bots 2604. The result is that changes in any commands 2801 supported by the RPA system 2600, or addition of new commands 2801 to the RPA system 2600, do not require an update of the execution environment on devices 2610, 2615. This avoids what can be a time and resource intensive process in which addition of a new command 2801 or change to any command 2801 requires an update to the execution environment to each device 2610, 2615 employed in an RPA system. Take, for example, a bot that employs a command 2801 that logs into an on-online service. The command 2801 upon execution takes a Uniform Resource Locator (URL), opens (or selects) a browser, retrieves credentials corresponding to a user on behalf of whom the bot is logging in as, and enters the user credentials (e.g., username and password) as specified. If the command 2801 is changed, for example, to perform two-factor authentication, then it will require an additional resource (the second factor for authentication) and will perform additional actions beyond those performed by the original command (for example, logging into an email account to retrieve the second factor and entering the second factor). The command action logic will have changed as the bot is required to perform the additional changes. Any bot(s) that employ the changed command will need to be recompiled to generate a new bot JAR for each changed bot and the new bot JAR will need to be provided to a bot runner upon request by the bot runner. The execution environment on the device that is requesting the updated bot will not need to be updated as the command action logic of the changed command is reflected in the new bot JAR containing the byte code to be executed by the execution environment.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

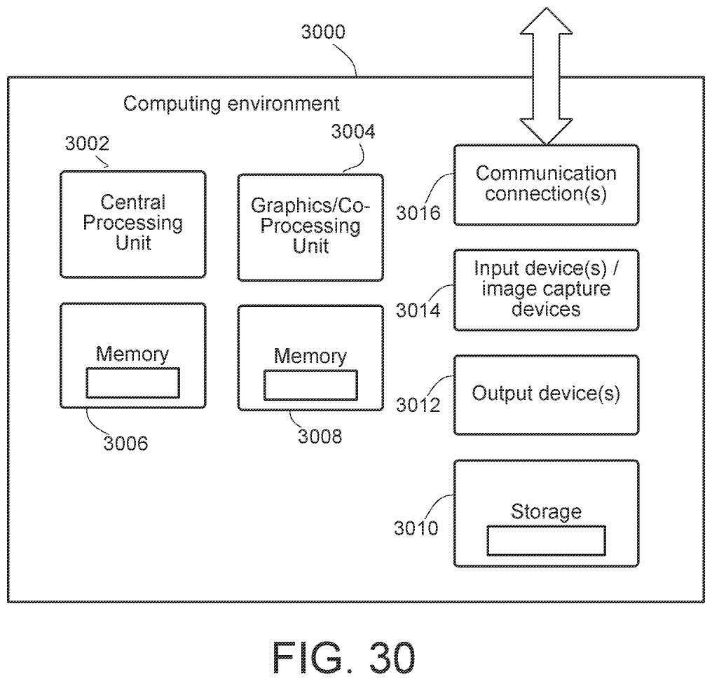

FIG. 30 illustrates a block diagram of an exemplary computing environment 3000 for an implementation of an RPA system, such as the RPA systems disclosed herein. The embodiments described herein may be implemented using the exemplary computing environment 3000. The exemplary computing environment 3000 includes one or more processing units 3002, 3004 and memory 3006, 3008. The processing units 3002, 3004 execute computer-executable instructions. Each of the processing units 3002, 3004 can be a general-purpose central processing unit (CPU), processor in an application-specific integrated circuit (ASIC) or any other type of processor. For example, as shown in FIG. 30, the processing unit 3002 can be a CPU, and the processing unit 3004 can be a graphics/co-processing unit (GPU). The tangible memory 3006, 3008 may be volatile memory (e.g., registers, cache, RAM), non-volatile memory (e.g., ROM, EEPROM, flash memory, etc.), or some combination of the two, accessible by the processing unit(s). The hardware components may be standard hardware components, or alternatively, some embodiments may employ specialized hardware components to further increase the operating efficiency and speed with which the RPA system operates. The various components of exemplary computing environment 3000 may be rearranged in various embodiments, and some embodiments may not require nor include all of the above components, while other embodiments may include additional components, such as specialized processors and additional memory.

The exemplary computing environment 3000 may have additional features such as, for example, tangible storage 3010, one or more input devices 3014, one or more output devices 3012, and one or more communication connections 3016. An interconnection mechanism (not shown) such as a bus, controller, or network can interconnect the various components of the exemplary computing environment 3000. Typically, operating system software (not shown) provides an operating system for other software executing in the exemplary computing environment 3000, and coordinates activities of the various components of the exemplary computing environment 3000.

The tangible storage 3010 may be removable or non-removable, and includes magnetic disks, magnetic tapes or cassettes, CD-ROMs, DVDs, or any other medium which can be used to store information in a non-transitory way, and which can be accessed within the computing system 3000. The tangible storage 3010 can store instructions for the software implementing one or more features of an RPA system as described herein.

The input device(s) or image capture device(s) 3014 may include, for example, one or more of: a touch input device, such as a keyboard, mouse, pen, or trackball, a voice input device, a scanning device, an imaging sensor, a touch surface, or any other device capable of providing input to the exemplary computing environment 3000. For multimedia embodiment, the input device(s) 3014 can, for example, include a camera, a video card, a TV tuner card, or similar device that accepts video input in analog or digital form, a microphone, an audio card, or a CD-ROM or CD-RW that reads audio/video samples into the exemplary computing environment 3000. The output device(s) 3012 can, for example, include a display, a printer, a speaker, a CD-writer, or any another device that provides output from the exemplary computing environment 3000.

The one or more communication connections 3016 can enable communication over a communication medium to another computing entity. The communication medium conveys information such as computer-executable instructions, audio or video input or output, or other data. The communication medium can include a wireless medium, a wired medium, or a combination thereof.

This application also references U.S. patent application Ser. No. 17/096,908, filed Nov. 12, 2020, entitled “AUTOMATED SOFTWARE ROBOT CREATION FOR ROBOTIC PROCESS AUTOMATION”, which are expressly incorporated by reference herein. Additional details and description of processing of recordings, merging recordings, and producing software automation robots are described in this incorporated U.S. patent application Ser. No. 17/096,908.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. In one embodiment, the computer readable medium is non-transitory. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A non-transitory computer readable medium including at least computer program code stored thereon for managing an automation workflow process capable of utilizing one or more software robots, one or more external applications and/or one or more human inputs, the computer readable medium comprising:
computer program code for processing a dataset by a first software robot to produce an automation result;
computer program code for detecting completion of the first software robot;
computer program code for processing the automation result by a first external application to produce processed data;
computer program code for detecting completion of the first external application;
computer program code for presenting a user interface including at least a portion of the processed data; and
computer program code for detecting receipt of a human input with respect to the user interface.

2. A non-transitory computer readable medium as recited in claim 1, wherein the first external application provides data extracted from an image of a document.

3. A non-transitory computer readable medium as recited in claim 1, wherein the first external application provides data extraction and/or validation of extracted data.

4. A non-transitory computer readable medium as recited in claim 1, wherein the first external application provides an evaluation of quality of data extracted from an image of a document.

5. A non-transitory computer readable medium including at least computer program code stored thereon for managing an automation workflow process capable of utilizing one or more software robots, one or more external applications and/or one or more human inputs, the computer readable medium comprising:
computer program code for processing a dataset by a first external application to produce processed data;
computer program code for detecting completion of the first external application;
computer program code for presenting a user interface including at least a portion of the processed data; and
computer program code for detecting receipt of a human input with respect to the user interface.

6. A non-transitory computer readable medium as recited in claim 5, wherein the first external application provides data extracted from an image of a document.

7. A non-transitory computer readable medium as recited in claim 5, wherein the first external application provides data, the data including a confidence indicator associated with data processing provided by the first external application.

8. A non-transitory computer readable medium as recited in claim 5, wherein the first external application provides an evaluation of quality of data extracted from an image of a document.

9. A non-transitory computer readable medium as recited in claim 5, wherein the computer readable medium comprises:
computer program code for processing at least a portion of the processed data by a first software robot to produce an automation result; and
computer program code for detecting completion of the first software robot.

10. A non-transitory computer readable medium as recited in claim 9, wherein the computer readable medium comprises:
computer program code for presenting another user interface including at least a portion of the automation result; and
computer program code for detecting receipt of a human input with respect to the another user interface.

11. A non-transitory computer readable medium including at least computer program code stored thereon for managing a workflow process using a software automation system, the computer readable medium comprising:
computer program code for providing input information to and requesting information from an external software application;
computer program code for receiving output information from the external software application;
computer program code for determining a characteristic of the output information that impacts the ability of the output information to be successfully utilized as input information for use by the software automation system or the workflow process;
computer program code for presenting a user interface able to receive user input from a human user; and
computer program code for receiving, via the user interface, a first input from the human user that supplements or alters the output information from the external application.

12. A non-transitory computer readable medium as recited in claim 11, wherein the computer readable medium comprises:
computer program code for receiving, via the user interface, a second input comprising instructions to accept the output information as supplemented or altered by the first input as input information for use by the software automation system or the workflow process.

13. A non-transitory computer readable medium as recited in claim 11, wherein the characteristic includes a quality indicator.

14. A non-transitory computer readable medium as recited in claim 11, wherein the characteristic includes a textual identifier.

15. A non-transitory computer readable medium as recited in claim 11, wherein the external software application provides OCR data extraction from an image of a document.

16. A non-transitory computer readable medium as recited in claim 11, wherein the external software application provides computer-determined labeling for a document.

17. A robotic process automation system, comprising:
a data store configured to store a plurality of software robots, the software robots providing automated interaction with one or more software programs operating on one or more computing devices;
a workflow process platform configured to enable users to (i) create automation workflow processes, and (ii) perform automation workflow processes that have been created,
wherein at least a particular automation workflow process of the created automation workflow processes includes a determined sequence of performing a plurality of tasks, at least one of the tasks in the determined sequence being a robotic task that is performed by one of the software robots, at least another of the tasks in the determined sequence being a human task that is performed to receive interaction with a person, and at least another of the tasks in the determined sequence being an interaction with a software application, and
wherein performance of the particular automation workflow process performs the tasks of the particular automation workflow process in the determined sequence, the performance including causing the one of the software robots for the robotic task to be performed, causing a user interface to be presented to the person in performing the human task, and causing interaction with the software application to provide data to the software application and received returned data from the software application.

18. A robotic process automation system as recited in claim 17, wherein the workflow process platform manages the performance of the particular automation workflow process by operating to at least:
determine a first task within the particular automation workflow process that is to be performed;
cause the first task to be performed on a first computing device;
receive an indication that the first task has completed;
determine a subsequent task within the particular automation workflow process that is to be performed after the first task;
cause the subsequent task to be performed on a second computing device; and
receive an indication that the subsequent task has completed.

19. A robotic process automation system as recited in claim 17, wherein, in creating the particular automation workflow process via the workflow process platform, the workflow process platform is configured to at least:
identify a first task to be included in the automation workflow process being created;
identify a second task to be included in the automation workflow process being created; and
arrange the second task to follow after the first task within the automation workflow process.

20. A non-transitory computer readable medium including at least computer program code stored thereon for managing an automation workflow process utilizing software robots, external applications and human input, the computer readable medium comprising:
computer program code for identifying a first human task to be included in the automation workflow process being created;
computer program code for configuring the first human task to present a user interface to a person and to capture a data input therefrom;
computer program code for identifying a first robotic task to be included in the automation workflow process being created;
computer program code for arranging the first robotic task to follow after the first human task within the automation workflow process being created;
computer program code for configuring the first robotic task to utilize a first software robot, and to receive as an input at least a portion of the data input that the first human task provided;
computer program code for identifying a first external application to be accessed during the automation workflow process being created;
computer program code for arranging the first external application to be accessed following after the first human task or the first robotic task within the automation workflow process; and
computer program code for configuring the automation workflow process to receive data from the first external application being accessed.

21. A non-transitory computer readable medium as recited in claim 20, wherein the computer program code for arranging the first external application to be accessed following after the first human task or the first robotic task within the automation workflow process, comprises:
computer program code for presenting a configuration user interface, the configuration user interface facilitating a user in specifying output data from the first robotic task that is to be provided as input data to the first external application.

22. A non-transitory computer readable medium as recited in claim 21,
wherein the first external application produces validated data, and
wherein the validated data from the first external application is directed by the automation workflow process as input to another task within the automation workflow process.

23. A non-transitory computer readable medium as recited in claim 20, wherein the computer readable medium comprises:
computer program code for supporting a validation user interface, the validation user interface facilitating a user in validating data acquired by or for the first external application.

24. A non-transitory computer readable medium as recited in claim 23, wherein the validation user interface concurrently presents (i) at least one item of textual data of an image of a document in a visually distinguished manner, and (ii) extracted text corresponding to the at least one item of textual data, the extracted text being programmatically recognized from the image of the document.

25. A non-transitory computer readable medium as recited in claim 24, wherein the validation user interface enables the user to validate the extracted data as correct for the at least one item of textual data of the image of the document.

26. A non-transitory computer readable medium as recited in claim 24, wherein the validation user interface enables the user to correct the extracted data for the at least one item of textual data of the image of the document.

27. A non-transitory computer readable medium as recited in claim 20, wherein the computer program code for arranging the first external application to be accessed following after the first human task or the first robotic task within the automation workflow process, comprises:
computer program code for presenting a configuration user interface, the configuration user interface facilitating a user in arranging the first external application to be accessed following after the first human task or the first robotic task within the automation workflow process.

28. A non-transitory computer readable medium as recited in claim 27, wherein the configuration user interface includes at least a first data input field to specify an element name; a second data input field to identify a task name, and a third data input field to specify a document identifier.

29. A method for managing a workflow process using a software automation system, the method comprising:
receiving, at the software automation system, output information from an external software application;
determining a quality of the output information, the quality of the output information corresponding to the ability of the output information to be successfully utilized as input information by the software automation system in carrying out the workflow process;
presenting a user interface configured to receive user input from a human user; and
receiving, via the user interface, (i) a first input comprising human input that supplements or alters the output information from the external application, and/or (ii) a second input comprising an instruction to utilize the received output information and/or the human input as input information for use by the software automation system in carrying out the workflow process.
